(19) United States
(12) Patent Application Publication
(10) Pub. No.: US 2013/0317870 A1
(43) Pub. Date: Nov. 28, 2013

(54) APPARATUS AND METHODS FOR PROCESS CHANGE CONTROL

(71) Applicants: Karen E. Franco, Ponte Vedra, FL (US); Janine Dela Merced, Ponte Vedra, FL (US); Christian Bowers, Elk Grove, CA (US)

(72) Inventors: Karen E. Franco, Ponte Vedra, FL (US); Janine Dela Merced, Ponte Vedra, FL (US); Christian Bowers, Elk Grove, CA (US)

(73) Assignee: Bank of America, Charlotte, NC (US)

(21) Appl. No.: 13/480,653

(22) Filed: May 25, 2012

(51) Int. Cl. G06Q 10/06

(52) U.S. Cl. 705/7.11

(57) ABSTRACT

Apparatus and methods for process change control are provided. Apparatus and methods in accordance with principles described herein may ascertain an employee readiness status. The readiness status may correspond to an ability to implement a process change. Process change control may provide a managed change readiness environment that consistently operates on target with minimal variation enabling a controlled, successful implementation of a process change. Implementation may be controlled through systematic observation, analysis, and reporting of process change requirements. Process change control may reduce deployment defects resulting from change implementation through a tailored, assessment and readiness/certification process.

### FIELD OF TECHNOLOGY

Aspects of the present disclosure relate to controlling implementation of a change in an operational process.

### BACKGROUND

A change to an operational process may alter a pre-existing process. A change to an operational process may implement a wholly new operational process. Employees charged with implementing the change may be accustomed to performing a process in a particular manner or not performing a particular process at all.

Implementation of a process change may be motivated by a concern. Exemplary concerns may include efficiency, improving customer satisfaction, a changing business model, changing demand, or changing demographics.

In today's fast-paced corporate environment, multiple business partners with small to midsize projects with process only changes, frequently deploy process changes without sufficient assessment of employee readiness, adoption factors and impact. As a result, newly-deployed changes often result in additional, and often duplicate, work for the employees and/or defects in processing. The defects or duplicate work may require development of additional workarounds and may initiate escalation procedures which may further delay implementation of the change.

A process change may require that employees adapt and learn how to successfully implement the changed process. It may be challenging for employees to successfully implement the change without preparation prior to the implementation of, or feedback during, the implementation.

A change deployed without adequate preparation may cause an unsuccessful implementation of the change. Without adequate preparation, employees may not possess training to successfully implement the change.

A failed implementation of the process change may fail to address the concern motivating the change. Defects in performance of the change may require development of workarounds or further process changes. These additional steps may delay successful implementation of the operational process and may impose additional overhead costs. A defect in performance of the operational process may require that the change be abandoned. Abandonment may result in a waste of resources expended attempting to implement the change.

Employees unable to successfully implement the changed process may suffer from frustration or reduced morale. Employee frustration may impose costs associated with deployment of the operational process change.

For example, employee frustration may increase a rate of attrition or decrease job satisfaction. Employee frustration may have a “spill-over” effect on tasks unrelated to the process change. For example, mental distraction may cause a frustrated employee perform routine tasks improperly.

A process change deployed without a sufficient assessment of readiness factors, adoption factors or an impact on the overall operation may result in additional costs to the implementing institution. A sufficient assessment prior to deploying the change may avoid the aforementioned challenges.

It would be desirable to reduce deployment defects and rework in response to an unsuccessful process change implementation. It would be desirable to increase employee satisfaction and efficiency by reducing cycle time to successful implementation of a process change. It would be desirable to develop apparatus and methods to review employee readiness and adoption considerations prior to, during and after deploying a process change. It would be desirable, therefore, to provide apparatus and methods for process change control.

### SUMMARY

Apparatus and methods for controlling implementation of a change to an operational process are provided.

Methods may include receiving an input based on a performance. Methods may include discriminating, in the input, between: (a) a preparation defect, (b) an implementation defect, and (c) a threshold selection error. Methods may include, based on the discriminating, providing an outcome and based on the outcome, adjusting a feedback. The feedback may regulate and/or affect the performance. Methods may include certifying the performance when the input satisfies a certification score.

Methods may include defining an operational goal of the change and setting a target discriminator based on the operational goal. Methods may include determining an operational-readiness score based on the operational goal.

If the operational-readiness score exceeds a pre-determined threshold value, methods may include deploying the change. If the operational-readiness score does not exceed the pre-determined threshold value, methods may include identifying a defect in a readiness criterion.

Methods may include determining a post-deployment score based on operational metrics measured after the deploying and comparing the post-deployment score to the target discriminator. Methods may include, based on the comparing, identifying a defect in the deploying or modifying the pre-determined threshold value.

Apparatus may include an article of manufacture including a computer usable medium having computer readable program code embodied therein for achieving a target of a performance. The computer readable program code in said article of manufacture may include computer readable program code for causing a computer to receive an input based on the performance.

Apparatus may include computer readable program code for causing a computer to discriminate, in the input, between a preparation defect, an implementation defect and a threshold selection error.

Apparatus may include computer readable program code for causing a computer to, based on the discriminating, provide an outcome. Apparatus may include computer readable program code for causing a computer to, based on the outcome, adjust a feedback that may be used to regulate and/or affect the performance. Apparatus may include computer readable program code for causing a computer to certify the performance when the input satisfies a certification score.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative process in accordance with principles of the invention;

FIG. 2 shows illustrative information that may be used in accordance with principles of the invention;

FIG. 3 shows illustrative information that may be used in accordance with principles of the invention;

FIG. 4 shows illustrative information that may be used in accordance with principles of the invention;

FIG. 5 shows an illustrative process in accordance with principles of the invention;

FIG. 6 shows an illustrative process in accordance with principles of the invention;

FIG. 7 shows an illustrative process in accordance with principles of the invention;

FIG. 8 shows illustrative information that may be used in accordance with principles of the invention;

FIG. 9 shows illustrative information that may be used in accordance with principles of the invention; and

FIG. 10 shows a schematic diagram of a general purpose digital computing environment in which one or more aspects of the present invention may be implemented.

### DETAILED DESCRIPTION OF THE DISCLOSURE

Apparatus and methods for process change control are provided. Apparatus and methods in accordance with principles described herein may ascertain an employee readiness status. The readiness status may correspond to an ability to implement a process change. The status may also correspond to adoption considerations prior to and after deploying process changes for large, small and/or mid-size projects.

Successful implementation of a process change may be controlled through systematic observation, analysis, and reporting of project requirements to reduce deployment defects. The observation may include monitoring “hard” numerical metric and “soft” behavioral metrics. Exemplary hard metrics may include a number of loans issued or a number of customer complaints. Exemplary “soft” metrics may include adherence to a protocol or performing a task in a particular manner. Observed “hard” and “soft” metrics may determine a score associated with the process change.

Apparatus and methods may reduce deployment defects and unnecessary reworks associated with a process change. Apparatus and methods may provide a managed change readiness environment that consistently operates with minimal variation, enabling a controlled transition to successful implementation.

Apparatus and methods may increase employee satisfaction and efficiency by reducing cycle time to successful implementation. Apparatus and methods may reduce employee turnover by building increased employee confidence and satisfaction through successful process change deployments.

Apparatus and methods may provide executive leadership of an institution immediate and clear line of sight to project readiness status through enhanced reporting routines and “go/no go” decision forums. Apparatus and methods may foster proactive consulting among employees tasked with implementing a process change to share best practices and assess readiness considerations. Apparatus and methods may increase credibility of a change implementation process by delivering increased change adoption rates, increased confidence in leadership's ability to regulate change release timelines and coordinate project deployments. Apparatus and methods may improve “right the first time” deployment performance through standardized deployment and control procedures.

Methods for process change control are provided. The methods may include a method for achieving a performance target. Methods may include receiving an input based on the performance. The performance may include activities of one or more employees tasked with implementing a process change. The one or more employees may form a project team. The project team may be tasked with implementing a process change. The performance may include an attempt to implement the process change. The target may correspond to a successfully implementation of the change.

Methods may include discriminating, in the input, between a preparation defect, an implementation defect and a threshold selection error. The preparation defect may indicate that the employee or project team did not possess adequate preparation to implement the process change. The implementation defect may indicate a flaw in the performance implementing the process change. The threshold selection error may indicate that assumptions with respect to requirements associated with the process change were incorrect.

The preparation defect may arise in response to a failure to provide training that addresses a requirement associated with the change. The preparation defect may arise from a failure of trainers to effectively convey skills to employees implementing the change.

The preparation defect may arise in response to a complexity of the process change. An employee may not have received training commensurate with a degree of complexity associated with the project change. Complexity associated with the project change may be caused by an intrinsic characteristic of the project change or an effect of the project change on another process. An initial planning of the change may not have appreciated the complexity.

The preparation defect may arise from a failure of an employee or project team implementing the process change to possess a skill set demanded by the process change. Exemplary skills that may be demanded of an employee/project team participating in a process change implementation are listed below. List 1A includes exemplary skills associated with management of the project team. List 1B lists exemplary skills associated with individual members of the team:

### List 1A: Exemplary Team Management Skill Set

Strong ability to apply Project Management and/or Six Sigma methodologies Proven Process Design and Change/Project Management experience leading large, medium and small indicatives
Experience with Associate Readiness processes and measuring production
Proven analytical, data mining and data management experience
Strong ability to confidently express thoughts and to speak up (appropriately) when something is not right
Excellent communication and presentation skill with a proven ability to deliver information to multiple levels of management—both verbally and written
Appropriate influencing skills and experience in driving consensus in diverse groups
Software experience, e.g., one full time team member with database experience is required to administer the scoring process
Strong attention to detail and ability to ensure thoughts are grounded in fact—“see the forest through the trees
Project Management Professional (PMP) Certification—desired
Excellent process mapping skills
Strong leadership skills and ability to engage collaboratively across multiple sites and project teams

### List 1B: Exemplary Team Member Skill Set

Strategic thinking: Be able to see and work in the big picture but be able to manage and appreciate the detail
Works independently in common software, e.g. Word, Excel or Power Point
Strong written and verbal communication skills, with attention to detail
“Know the audience” Good understanding of the broader organization enterprise, governance routines
Open to feedback and works well and openly with peers and business partners adapt to change and be able to react quickly
Strong organizational skills
Be able to communicate clear and concise presentations

The implementation defect may indicate that the process change has not been effectively adapted or has not achieved a desired effect. The implementation defect may indicate non-compliance with a component of the process change.

An undesirable performance may cause an implementation defect. The undesirable performance may include a failure to sufficiently implement the process change. The failure may include missing a target efficiency goal associated with the process change.

For example, a project charter associated with the process change may project that implementation of the change will yield a net 5% increase in a number of customer loans issued by an institution. The implementation defect may reflect that actual implementation of the process change only yields a net 0.7% increase in the number of customer loans issued by the institution.

The implementation defect may include a consequence of a failed implementation of the process change. A failed implementation may have a negative effect on employee confidence. The negative effect on employee confidence may decrease overall employee productivity.

A failure of a member of a project team to fulfill a designated role associated with implementing the process change may cause an implementation defect. The designated role may be defined as part of the pre-deployment training or preparation.

In planning an implementation of a process change, a threshold level of preparation may be anticipated. Input from the performance may include an indication that the threshold level of preparation currently associated with the process change may not correspond to sufficient preparation to successfully implement the process change. A threshold selection error may indicate that a project team has adopted pre-performance preparation protocol. However, actual implementation of the process change may demonstrate that different or additional preparation may be required to successfully implement the process change.

A failure to accurately assess a skill set demanded by the process change may cause a threshold selection error. For example, a process change may include a changed protocol for interacting with a customer. The changed protocol may elicit an unanticipated response from the customer. Training received by an employee may not have included instructions on how to handle the unanticipated response from the customer.

As a further example, implementation of the process change may leave less time for an employee to complete a pre-existing duty. Training provided prior to implementation of the change may not have imparted in the employee skills needed to manage an increased workload.

As a further example, a project team may discover that in implementing the process change, additional technology resources are required. The additional technology resources may require additional or different training from the training originally provided. As a further example, the project team may discover that implementation of a process change may require interaction with a different project team. Joint information sessions with the two project teams may be required to successfully implement the process change.

Methods may include, based on the discriminating, providing an outcome. The outcome may include an indication of an error or defect in the performance. The outcome may indicate that the input includes a threshold selection error. The outcome may indicate that the input includes a preparation defect. The outcome may indicate that the input includes an implementation defect.

Methods may include, based on the outcome, adjusting a feedback that feeds back into the performance. The feedback may include recommended steps to improve the performance. The feedback may include a remedial action. The feedback may include a directive to postpone implementation of the process change.

The remedial action may include steps to correct defects or errors indicated in the outcome. The feedback may provide directions for successfully implementing the process change.

For example, if the outcome includes a threshold selection error, the feedback may include a remedial action suggesting additional training to correct the threshold selection error.

As a further example, the outcome may include a performance defect. The feedback may include a remedial action indicating that the process change is not viable. The remedial action may suggest aborting the process change and not expending any further resources on implementation.

If the outcome includes a performance defect, the feedback may include a remedial action indicating that management of the project team has not spent sufficient time providing guidance to project team members. The remedial action may include a directive to the management on how to provide sufficient guidance.

For example, the outcome may indicate that although management was directed to consult with employees three times a week, during the performance management consulted with employees two times a week. The feedback may include a remedial action directing the management to adhere to the three times a week consulting schedule.

As a further example, the outcome may include a preparation defect. The outcome may indicate that during implementation of the process change, the project team did not have sufficient control over concurrent tasks unrelated to the process change. The feedback may suggest that a pre-deployment preparation routine be re-executed by the project team.

Methods may include certifying the performance when the input satisfies a certification score. The certification score may be selected based on the target of the performance. Certification of the performance may indicate that the process change has been successfully implemented. Certification of the performance may indicate that the process change has successfully achieved a desired or projected effect.

The discriminating may include receiving a pre-deployment score based on the input. The pre-deployment score may provide a standardized validation tool to ensure one or more employees are provided with systematic preparation to support a process change.

The pre-deployment score may include scoring completion of preparatory tasks undertaken prior to the performance. The scoring may be conducted internally by a project team that conducts the performance. The scoring may conducted by an outside observer of the performance.

The pre-deployment score may correspond to a level of preparation prior to engaging in the performance. The process change may be associated with a target pre-deployment score. The target pre-deployment score may correspond to a characteristic feature or requirement of a successful process change implementation. The target pre-deployment score may correspond to a minimal level of preparation required prior to implementing a process change.

The pre-deployment score may correspond to a collaborative effort among members of a project team. For example, the pre-deployment score may include a score corresponding to managerial action and a score corresponding to associate action. The pre-deployment score may include a score corresponding to operational, system, associate, or team leader-readiness criteria.

Determining the pre-deployment score may include completing a pre-deployment assessment form. The form may be completed by an evaluator. The form may facilitate scoring a readiness criterion. The readiness criterion may correspond to a pre-performance preparation task. Scoring the readiness criterion may occur prior to engaging in the performance implementing the process change. Scoring the readiness criterion may occur after engaging in the performance implementing the process change.

The form may include details regarding key components of a readiness criterion. The key components may be considered by an evaluator scoring the readiness criterion. The key components may correspond to specific tasks associated with a successful completion of the readiness criterion.

The form may include specific detail on how to conduct the assessment. The specific detail may guide the evaluator scoring the readiness criterion. The specific detail may inform the evaluator what to examine in evaluating completion of the readiness criterion.

The form may include specific scoring parameters consistent with the target of the performance. For example, the form may direct the evaluator to select whether the readiness criterion “meets” or “does not meet” a key component of the readiness criterion. The evaluator may select “does not meet” if significant completion of the key components has not been achieved. The evaluator may select “meets” if completion of the key component has been achieved.

The pre-deployment assessment form may include an observations section. The observations section may allow the evaluator to enter additional detail relating to completion of the readiness criterion. For example, if the target of the performance is not achieved, the evaluator may suggest a remediation plan. The remediation plan may outline steps for completing a readiness criterion or achieving the target performance. The remediation plan may correspond to the feedback. The remediation plan may correspond to additional training.

In some embodiments, if the evaluator indicates that a readiness criterion has not been successfully implemented, the form may require that the evaluator select a remediation plan to cure a deficiency in the readiness criterion.

The pre-deployment score may correspond to a level of pre-performance preparation. The feedback may be based on the pre-deployment score. The feedback may include a minimum level of pre-performance preparation. The feedback may include a directive to postpone further performance until the minimal level of pre-performance preparation is achieved.

The discriminating may include receiving a post-deployment score based on the input. The post-deployment score may correspond to an evaluation of compliance with a routine associated with the process change. The post-deployment score may be based on measuring a compliance frequency of a routine associated with the target. The compliance frequency may correspond to how often an employee acts in compliance with a protocol instituted by a process change.

Determining the post-deployment score may include completion of a post-deployment assessment form. The form may be completed by an evaluator. The form may facilitate scoring compliance with a routine mandated by the process change. Scoring compliance with the routine may occur after engaging in the performance.

The post-deployment assessment form may identify an employee or class of employee associated with the routine. The employee or class of employee may be responsible for executing the routine in conformance with the process change. For example, the routine may be a milestone associated with a component of the process change. The form may associate the milestone with a particular employee or class of employees.

The post-deployment assessment form may include criteria. The criteria may include adoption factors to be validated. The evaluator conducting the scoring may consider the criteria in ascertaining compliance with the routine. For example, if the routine includes a specific milestone associated with the process change, the criteria may include an instruction to compare activities of the employee associated with the milestone to activities documented in a policy and procedure manual.

The post-deployment assessment form may include information on how to evaluate the routine. The form may include information on how to review actions taken an employee relevant to compliance with the routine. Information included in the form may inform the evaluator how to evaluate compliance with the routine.

For example, the form may direct the evaluator to review “hard” metrics, such as achieving production quotas. The form may direct the evaluator to review “soft” behavioral metrics such as adherence to newly deployed protocol.

The post-deployment assessment form may include a scoring section. The scoring section may outline specific scoring parameters consistent with compliance with the routine. The parameters may guide the evaluator scoring the post-deployment assessment. For example, the form may include a selection of choices including “exceeds,” “meets,” “too new to rate,” “does not meet,” or “n/a.” In response to evaluating compliance with the routine, the evaluator may select one of the choices associated with the routine. The choice selected by the evaluator may correspond to a numeric score.

In response to a total score of routines evaluated, the performance may be certified. For example, the performance may be certified if the post-deployment score exceeds or meets a score associated with the target of the performance. A certified performance may correspond to a successfully-implemented process change.

The post-deployment assessment form may include an observations section. The observations section may allow the evaluator to enter additional detail or notes. For example, if the evaluator determines that there has been a low level of compliance with the routine, the evaluator may suggest a remediation plan. The remediation plan may outline steps for achieving full compliance. The remediation plan may correspond to the feedback.

In some embodiments, if the evaluator indicates unsatisfactory compliance with a routine, the form may require that the evaluator to select a remediation plan to cure a deficiency in the compliance. For example, if the post-deployment score indicates that employees have not consistently complied with a particular routine, the feedback may include a compliance frequency minimum value.

The outcome may include a threshold selection error. The threshold selection error may occur when the pre-deployment score indicates that employees obtained adequate preparation prior to conducting the performance and the post-deployment score is below the certification score. The threshold selection error may occur when the post-deployment score equals or exceeds the certification score and the pre-deployment score indicates that employees did not receive adequate training.

When the outcome includes the threshold selection error, the feedback may include adjusting the certification score. When the outcome includes the threshold selection error, the feedback may include adjusting a pre-deployment score that must be achieved prior to deployment of a process change.

Adjusting the certification score may correspond to raising or lowering an expected level of compliance associated with one or more routines. The routines may form part of the process change. Adjusting the pre-deployment score that must be achieved prior to deployment of a process change may correspond to raising or lowering a required level of preparation prior to engaging or re-engaging in the performance.

Methods for reducing defects associated with a change in an operational process are provided. The methods may include defining an operational goal of the change. Defining the operational goal may include capturing project information and ensuring that each process change is associated with a relevant and accurate primary metric. The primary metric may correspond to an anticipated effect or result of implementing the change.

For example, the primary metric may correspond to an improved cycle time associated with a process. Implementing the change may be motivated by a desire to reduce the cycle time associated with the process. The primary metric may correspond to the reduced cycle time.

Defining the operational goal may include identifying an operational requirement of the change. Defining the operational goal may include identifying an expected output produced by fulfillment of the operational requirement. The operational requirement may include identifying expected requirements for successful implementation of each component of the process change. The operational requirement may include identifying an expected output of each component of the process change.

Defining the operational goal may include identifying a target level of performance associated with fulfillment of an operational requirement. Defining the operational goal may include defining a remedial process to minimize variation in the output produced by fulfillment of the operational requirement.

Defining the operational goal may include allocating responsibility for fulfillment of the operational requirement. Responsibilities may be allocated among members of a project team tasked with implementing a process change. The project team may include managers and associates. List 2A includes exemplary management responsibilities. List 2B includes exemplary associate responsibilities.

### List 2A: Managerial Responsibilities

Assist with training on quality project deliverables, such as defining project charters and control plans
Assess development of scorecard/certification criteria and to ensure quality readiness metrics and control plans
Partner with project teams to establish pre-deployment criteria, controls, for executing readiness assessments
Create tools to measure Pre-Deployment and Performance readiness and risks, and employee adoption of performance routines
Complete the pre- and post-performance assessments and certification of performance
Track and report the readiness and change adoption metrics and risks
Present the Pre-Deployment Assessment results for formal approval prior to deployment
Present Certification results for formal approval
Verify project requirements are being met and employee adoption of process change at 30 and 60 days after deployment through certification
Generate remediation plan(s)

### List 2B: Associate Responsibilities

Participate and provide readiness guidance/support to management
Participate on readiness forums with integration partners
Provide readiness consulting services to projects as needed
Maintain updated tools and reference materials
Participate & provide readiness contributions to management
For medium and large projects, participate in developing strategy
For medium and large projects, deployment planning, including resources, coordination of delivery & logistics, lead training debrief sessions escalate and/or resolve pre deployment issues

Embodiments may include setting a target discriminator based on the operational goal. The target discriminator may correspond to the certification score. The target discriminator may correspond to a successful implementation of the process change.

Methods may include determining an operational-readiness score based on the operational goal. Determining the operational-readiness score may include identifying a prerequisite operational task associated with the change and validating compliance with the prerequisite operational task. Methods may include determining the operational-readiness score based on the identifying and the validating.

Determining the operational-readiness score may include assigning a value to a performance parameter associated with a completion of a readiness task. Determining the operational-readiness score may include determining a score for the readiness task in response to completion/incompletion of key components of a readiness task.

The operational-readiness score may correspond to a projected pre-requisite level of training or preparation associated with a successful implementation of the operational process change. In some embodiments, the operational-readiness score may be determined using the pre-deployment assessment form.

If the operational-readiness score exceeds a pre-determined threshold value, methods may include deploying the change. An operational-readiness score that exceeds the threshold may indicate that adequate training and preparation have been provided prior to deploying the process change.

If the operational-readiness score does not exceed the pre-determined threshold value, methods may include identifying a defect in a readiness task. In some embodiments the process change may not be deployed until the defect in the readiness task is cured. In some embodiments the process change may not be deployed until the operational-readiness score meets or exceeds the threshold.

Methods may include determining a post-deployment score based on operational metrics measured after the deploying. The post-deployment score may measure compliance with routines associated with the process change. The post-deployment score may be determined utilizing the post-deployment assessment form.

Determining the post-deployment score may include calculating a first score based on adherence to a routine associated with the process change. Determining the post-deployment score may include calculating a second score based on a managerial performance. Determining the post-deployment score may include calculating a third score based on utilization of efficiency tools. Determining the post-deployment score may include calculating a total score based on the first, second and third scores or some suitable combination of two of the scores. The adherence to a routine, a managerial performance and/or a utilization of efficiency tools may be measured with respect to a performance of one or more employees tasked with implementing the process change.

Exemplary routines associated with the process change may include achieving a milestone associated with the process change, utilization of reporting resources available to the project team and/or providing guidance to employees.

Providing guidance to a member of the project team may include conducting a strategy session or coaching employees implementing the process change.

Methods may include comparing the post-deployment score to the target discriminator. Based on the comparing, methods may include identifying a defect in the deploying or modifying the pre-determined threshold value. Based on the comparing, the process change may be certified. A certified process change may correspond to a successfully implemented process change. The process change may be certified if the post-deployment score meets or exceeds the target discriminator. The process change may be certified is the post-deployment score meets or exceeds a certification score.

A post-deployment score less than the target discriminator may indicate that the process change has not been successfully implemented. A defect in a performance of employees executing routines and/or tasks associated with the process change may cause an unsuccessful implementation of a process change.

Methods may include, in response to the comparing, modifying the pre-determined threshold value. Modifying the pre-determined threshold value may correspond to associating additional or different preparation tasks with the process change. A post-deployment score less than the target discriminator may indicate that additional or different preparation may be required to successfully implement the process change.

Methods may include determining the post-deployment score at a first interval following deployment of the process change. Methods may include determining the post-deployment score at a second interval following deployment of the process change. Methods may include determining the post-deployment score at a third interval following deployment of the process change.

The first interval may be two weeks, the second interval may be four weeks and the third interval may be seven weeks. The intervals may be any suitable period of time. The intervals may be determined based on an amount of time that has elapsed following deployment of the process change.

Methods may include determining the post-deployment score at least twice by employees tasked with implementing a component of the process change. Methods may include determining the post-deployment score at least once by a third party. The third party may be an onsite deployment support team.

Apparatus may include an article of manufacture comprising a computer usable medium having computer readable program code embodied therein for achieving a target of a performance.

The computer readable program code in the article of manufacture may include computer readable program code for causing a computer to receive an input based on the performance.

The computer readable program code may cause a computer to discriminate, in the input, between a preparation defect, an implementation defect and a threshold selection error.

The computer readable program code may cause a computer to provide an outcome based on the discriminating. The computer readable program code may cause a computer to, based on the outcome, adjust a feedback that feeds back into the performance. The computer readable program code may cause a computer to certify the performance when the input satisfies a certification score.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

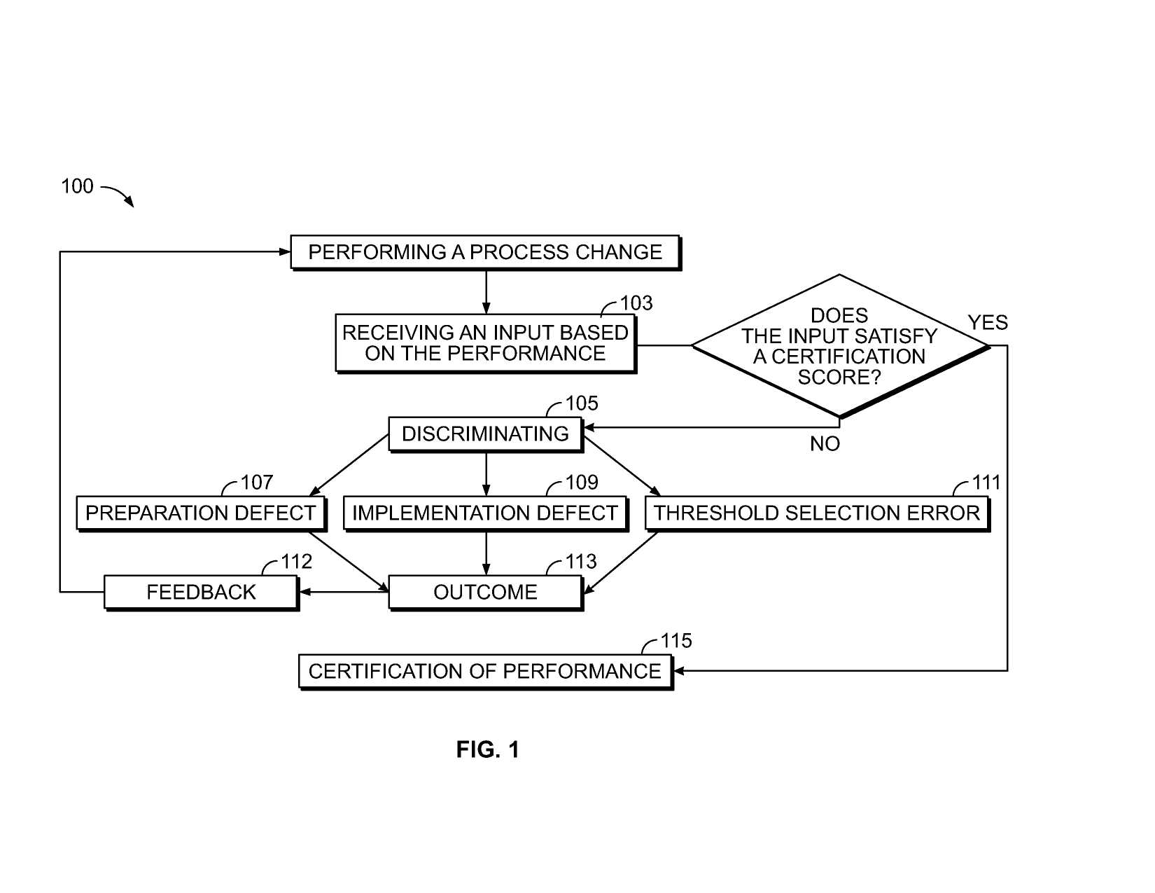

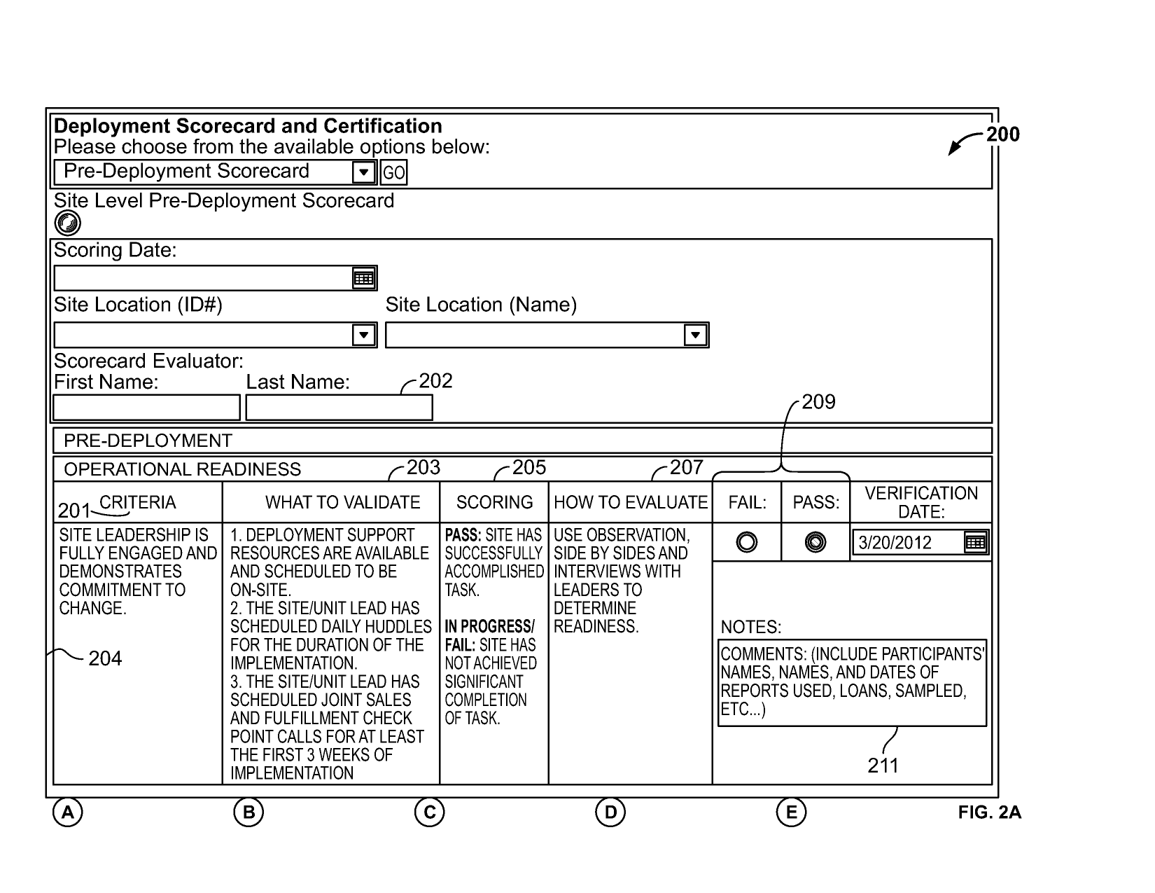

FIG. 1 shows illustrative process 100. Process 100 shows illustrative steps that may be taken by systems and methods (referred to hereinafter, collectively, as “the system”) in accordance with principles of the disclosure.

At step 101 the system performs a process change. The performing includes deploying the process change. At step 103, the system receives an input. The input is generating in response to the performance. At step 104, the system may determine if the input satisfies a certification score. If the input satisfies the certification score, the process change may be certified at step 115. Certification of the process change corresponds to achieving a target of the performance. The target may correspond to a successful implementation of a process change.

If the input does not satisfy the certification score, at step 105, the system discriminates the received input. The discriminating may include an analysis of the input. At step 107, the system detects a preparation defect. At step 109, the system detects an implementation defect. At step 111, the system detects a threshold selection error.

At step 113, the system produces an outcome in response to the discriminating. The outcome may be based on the implementation defect identified at step 109, the preparation defect identified at step 107 and/or the threshold error identified at step 111.

In response to the outcome, at step 112, the system may formulate feedback. The feedback may include one or more remedial actions to cure the implementation defect identified at step 109, the preparation defect identified at step 107 and/or the threshold error identified at step 111.

The feedback may be introduced into the performance. An input may be generated in response to the performance executed in conformance with the feedback.

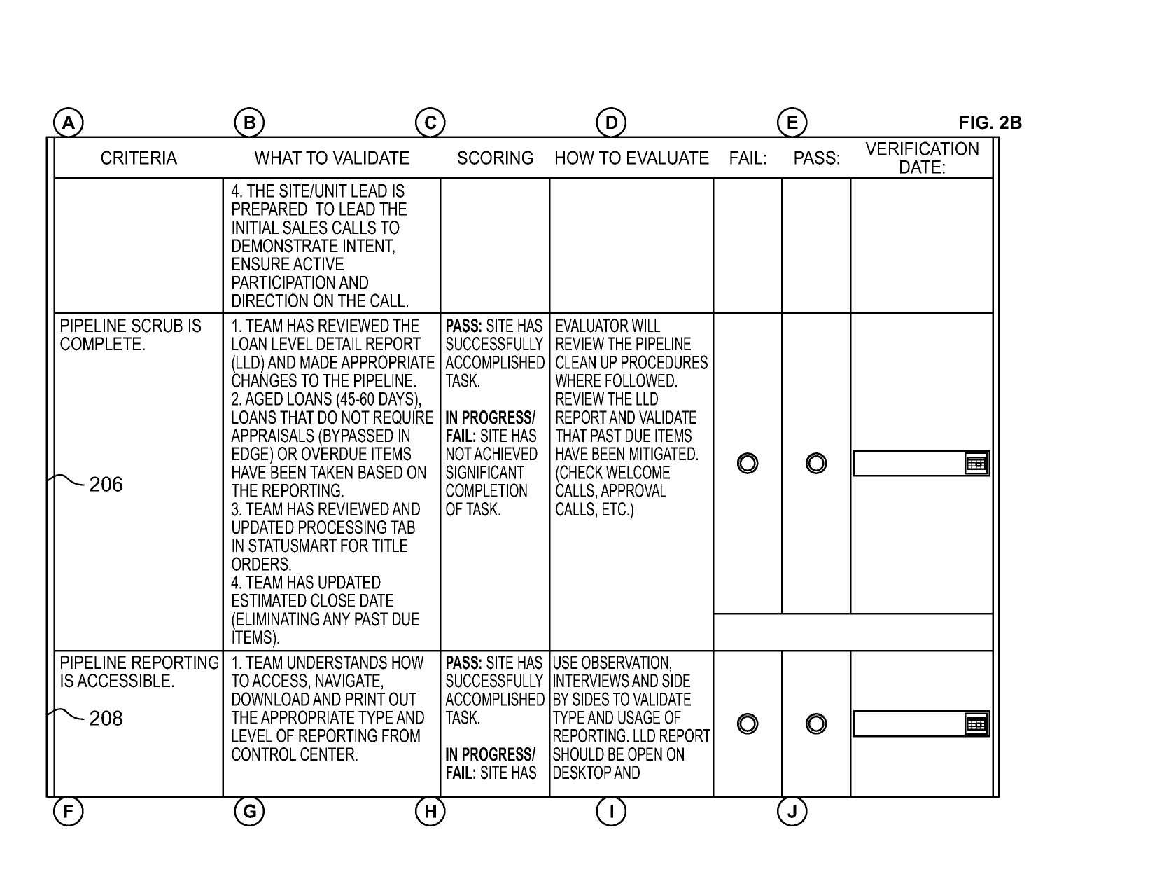

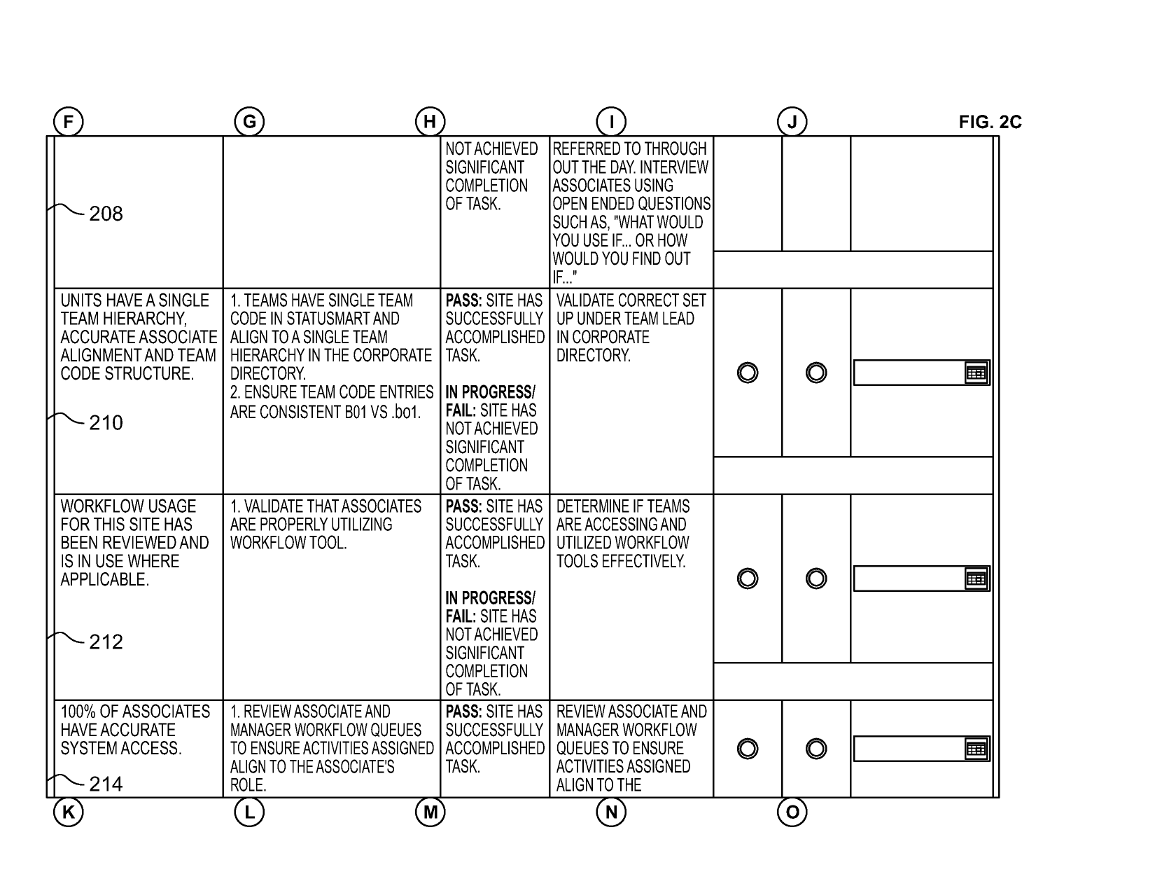

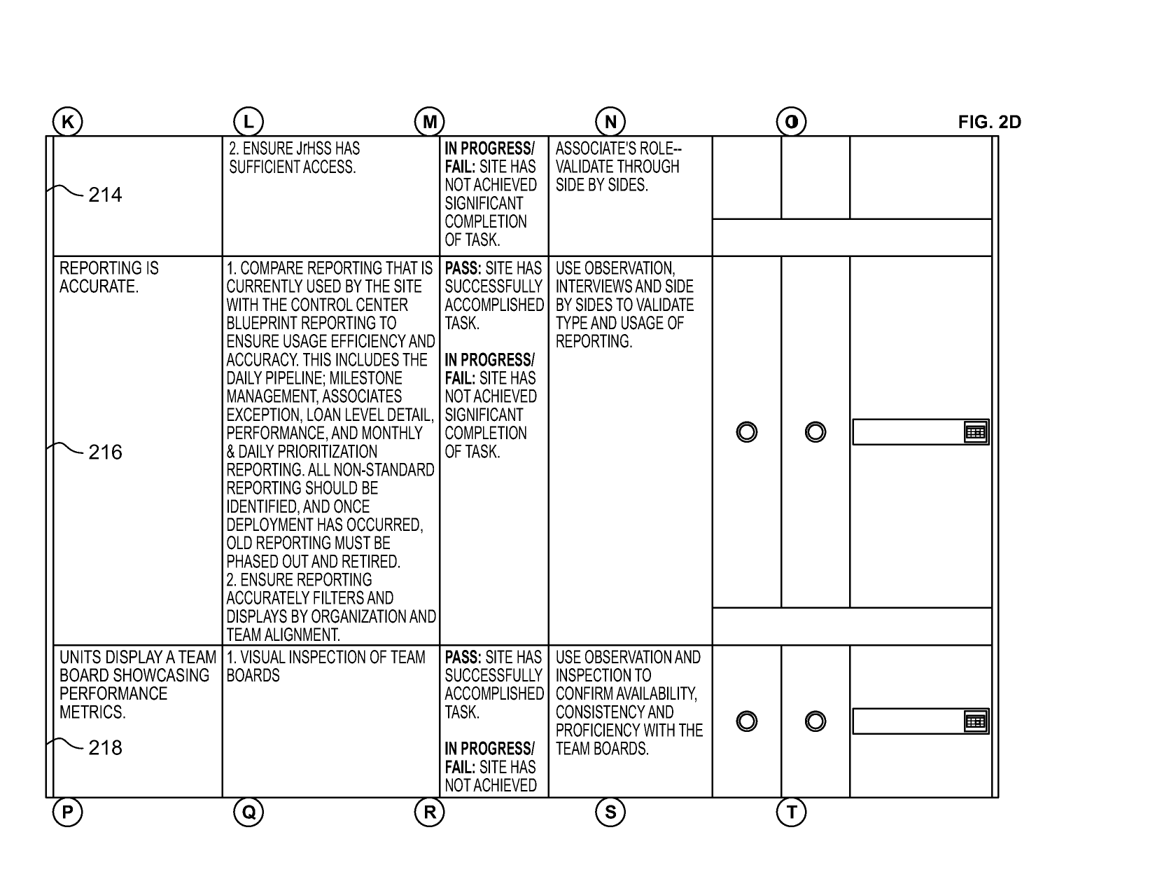

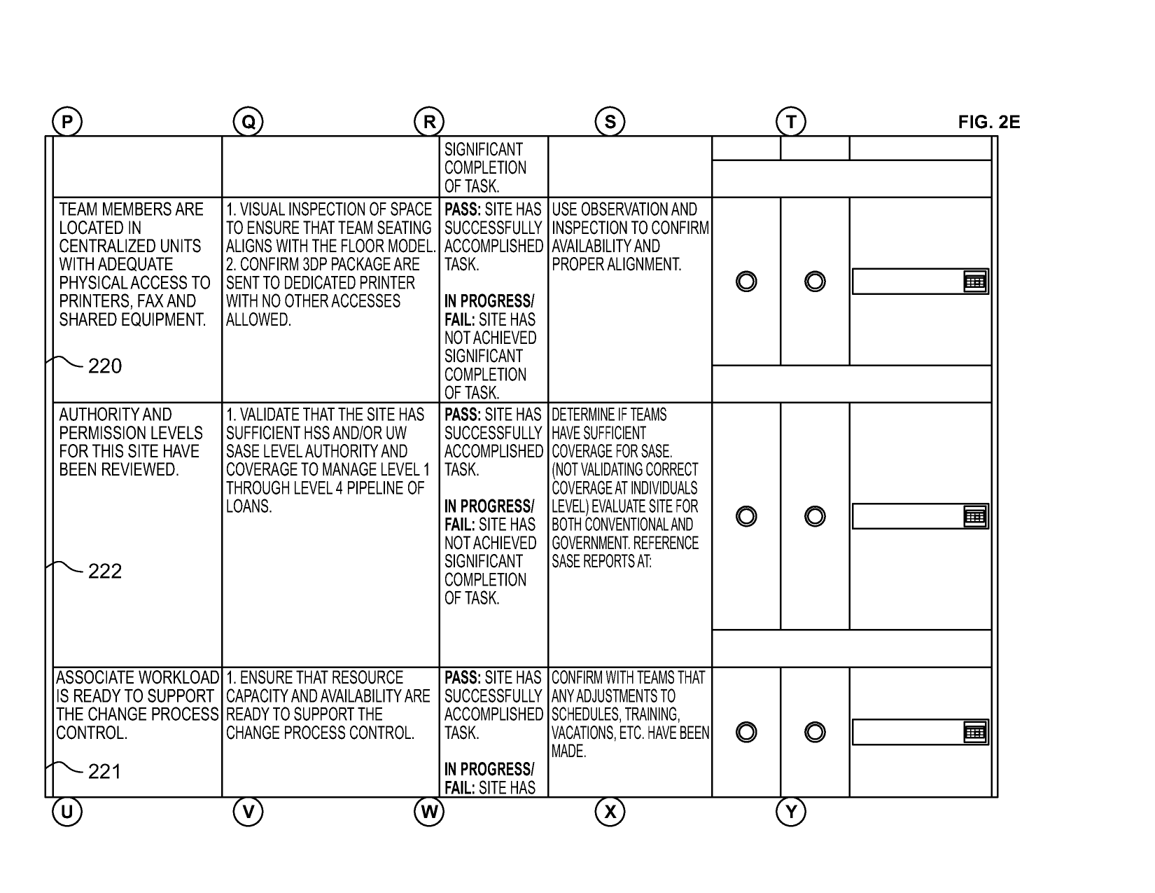

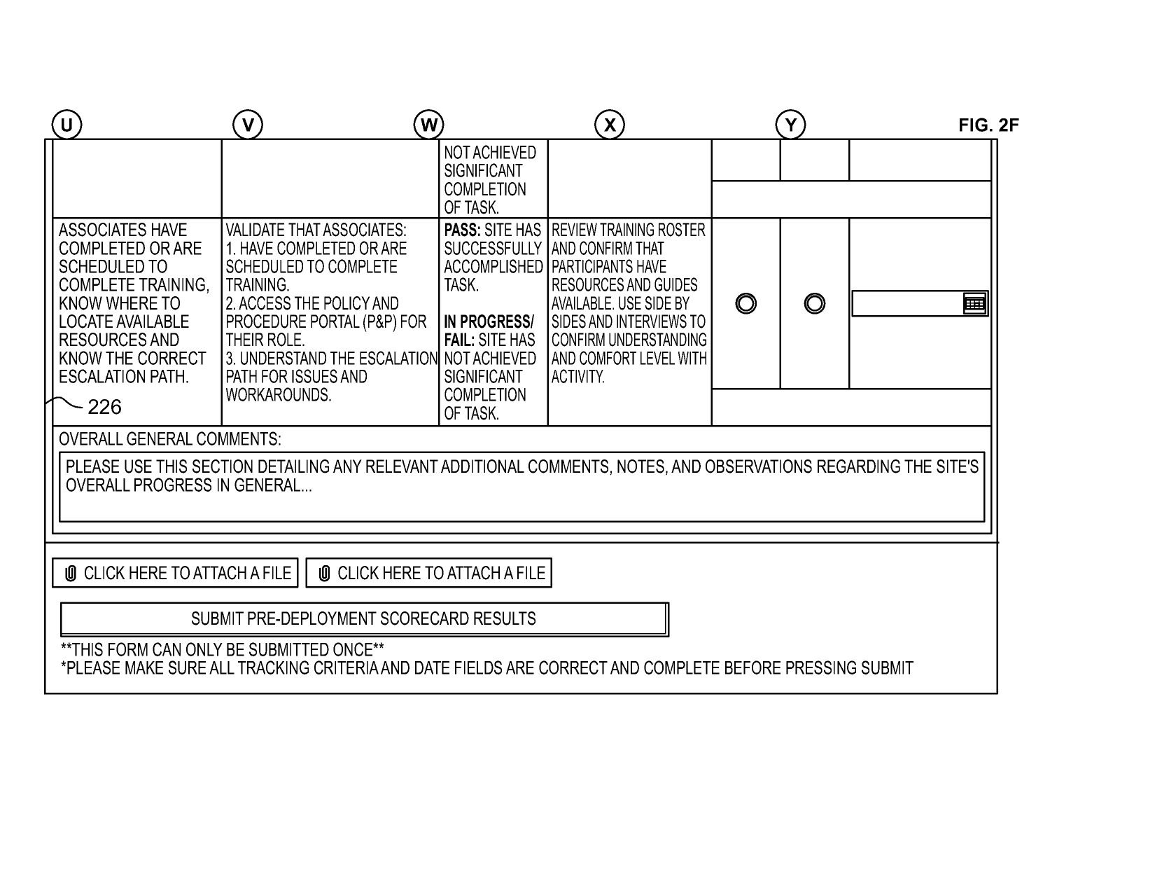

FIG. 2 shows illustrative information 200. Information 200 includes an illustrative pre-deployment assessment form. Column 201 lists illustrative readiness factors to be validated. Completion of each readiness factor may be considered by an evaluator 202. Each row 204-226 corresponds to a distinct readiness factor.

Information 200 includes illustrative criteria in column 201. Information 200 includes “what to validate” column 203. Column 203 includes key components associated with completion of each readiness factor listed in column 201.

Evaluator 202 conducting a pre-deployment assessment may consider the information in columns 203 and 205 before entering a score in “pass/fail” column 209. “Scoring” column 205 defines a relationship between column 203 and column 209.

The evaluator may enter a score in column 209 for each readiness factor listed in each of rows 204-226. Each score entered in column 209 may correspond to a degree of completion of a specific readiness factor. The scoring may correspond to satisfactory completion of a readiness factor. The scoring may correspond to unsatisfactory completion of a readiness factor. The scoring of a particular readiness factor may correspond to a specific defect or error in an implementation of a change to an operational process. In response to the scoring, a remedial action may be selected. The remedial action may be entered in observations section 211.

Information 200 may be systematically utilized for process changes deployed by an institution. Information 200 may be customized for a specific process change.

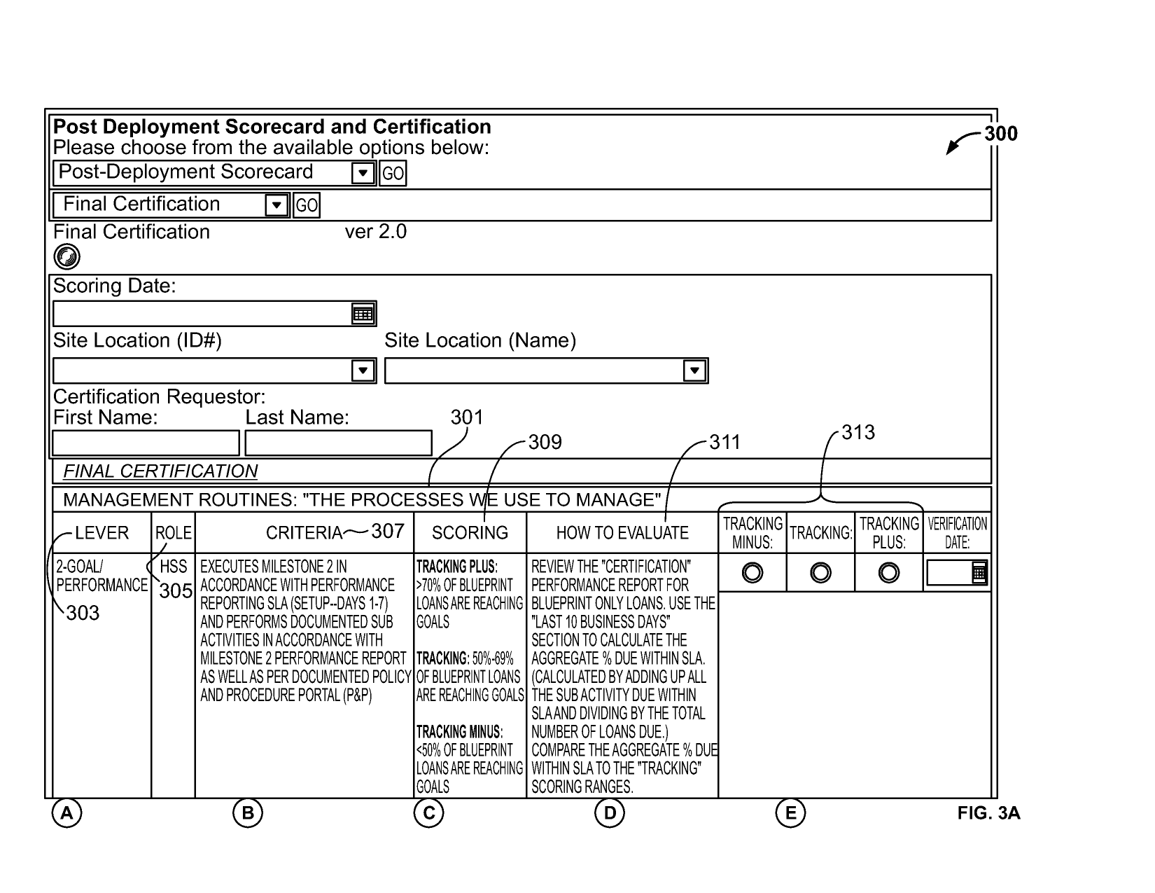

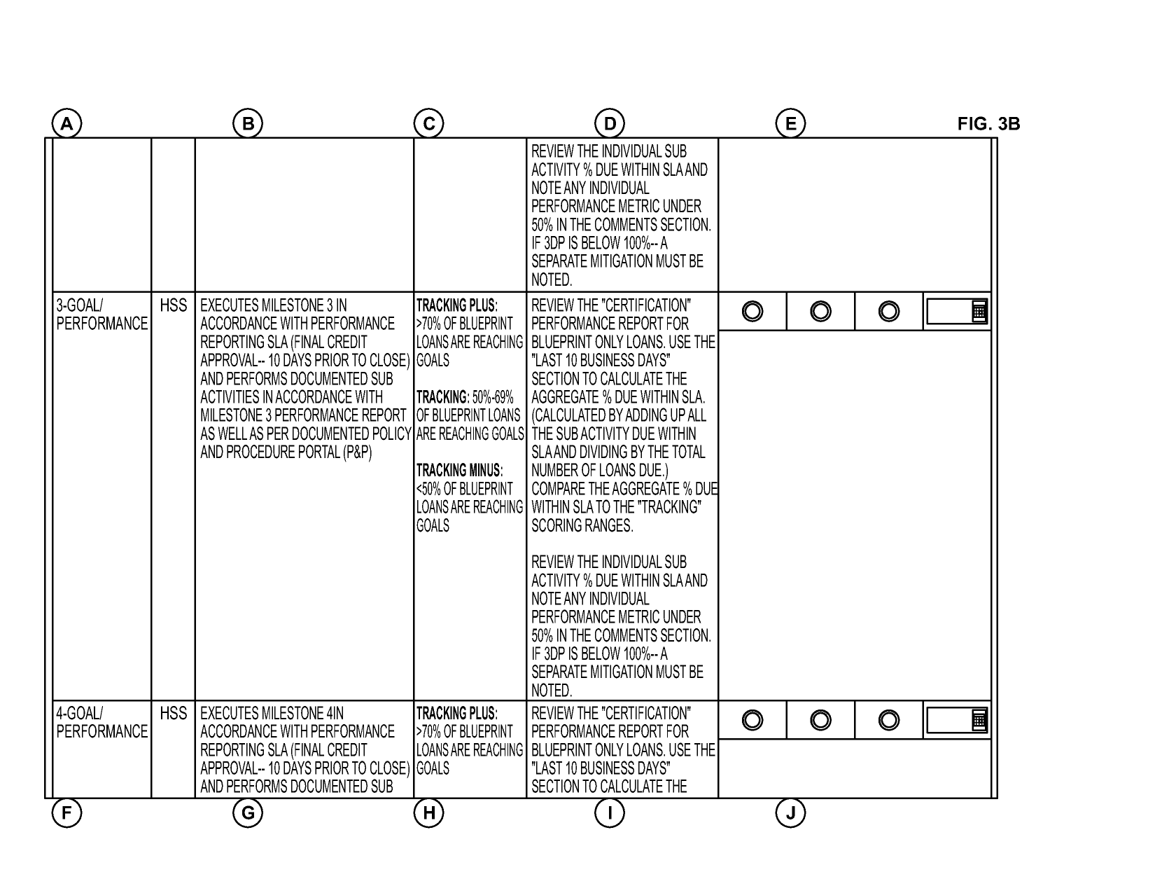

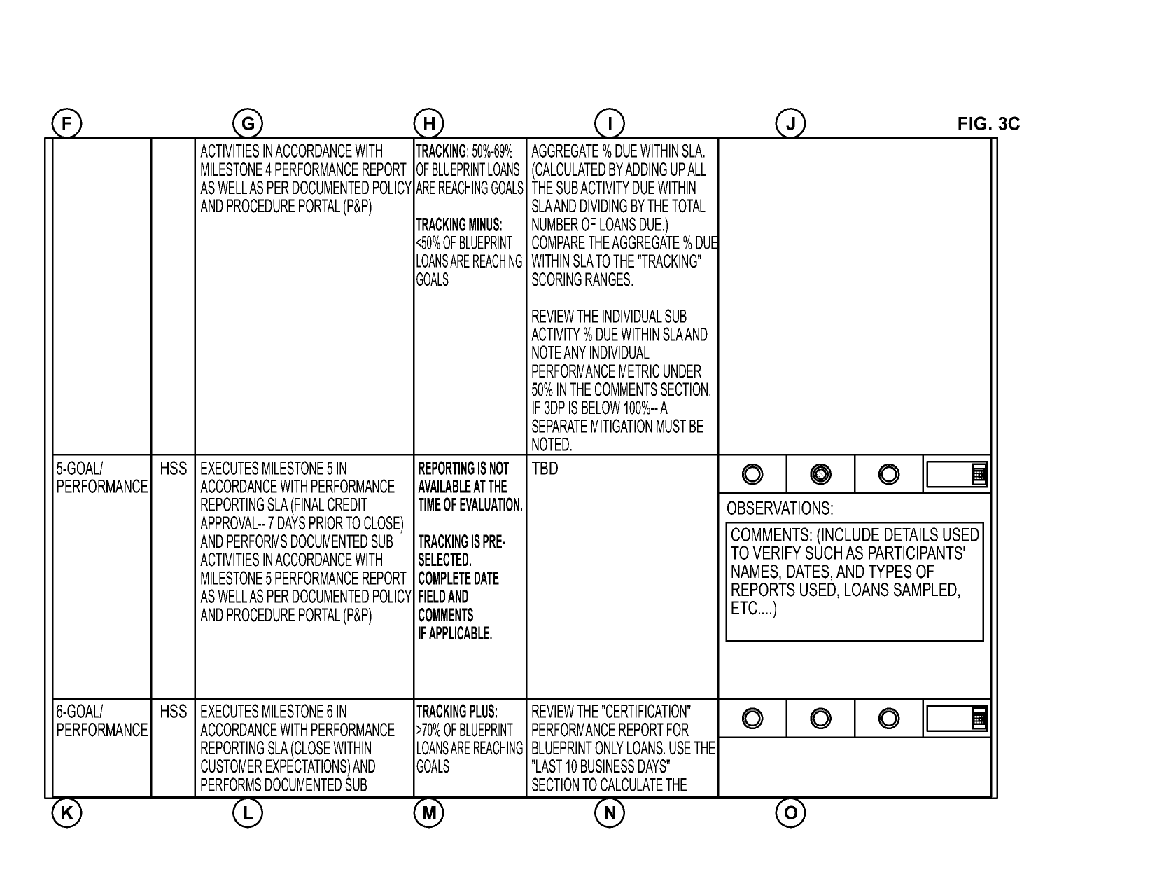

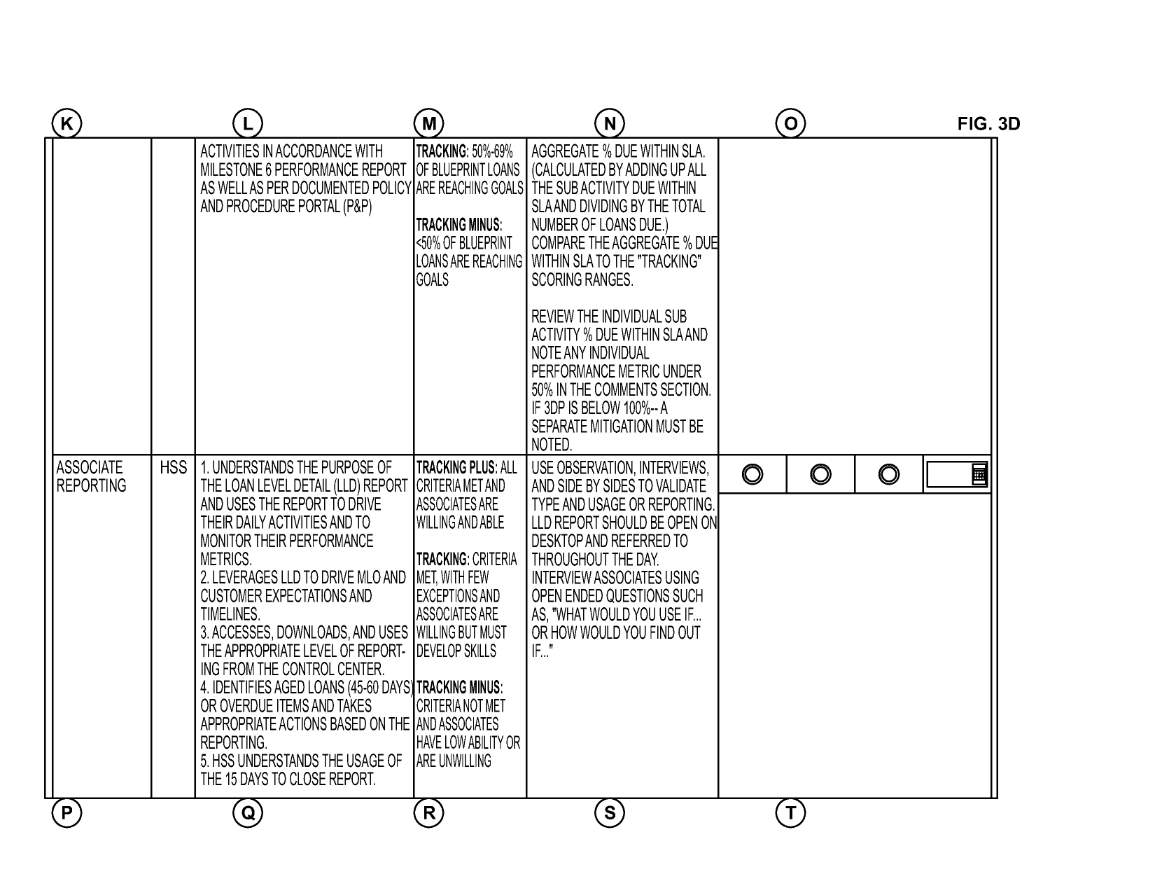

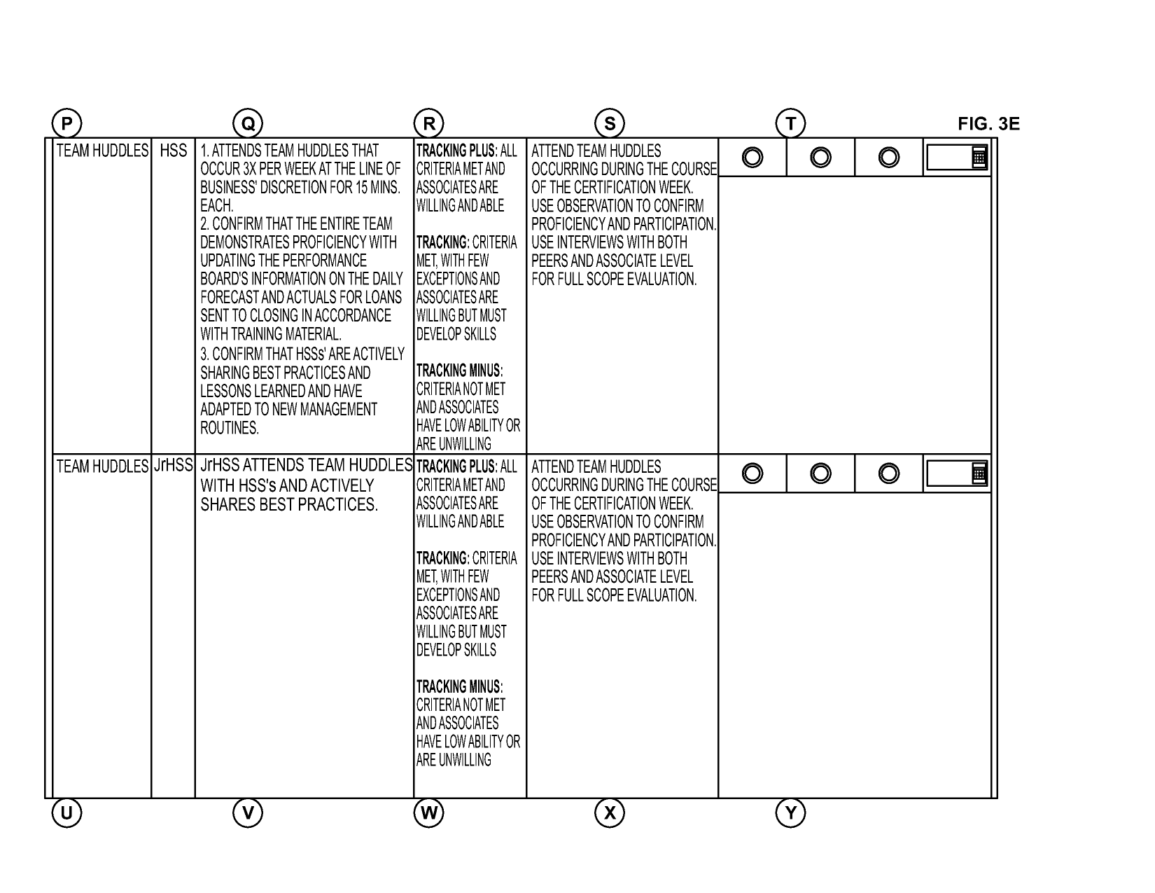

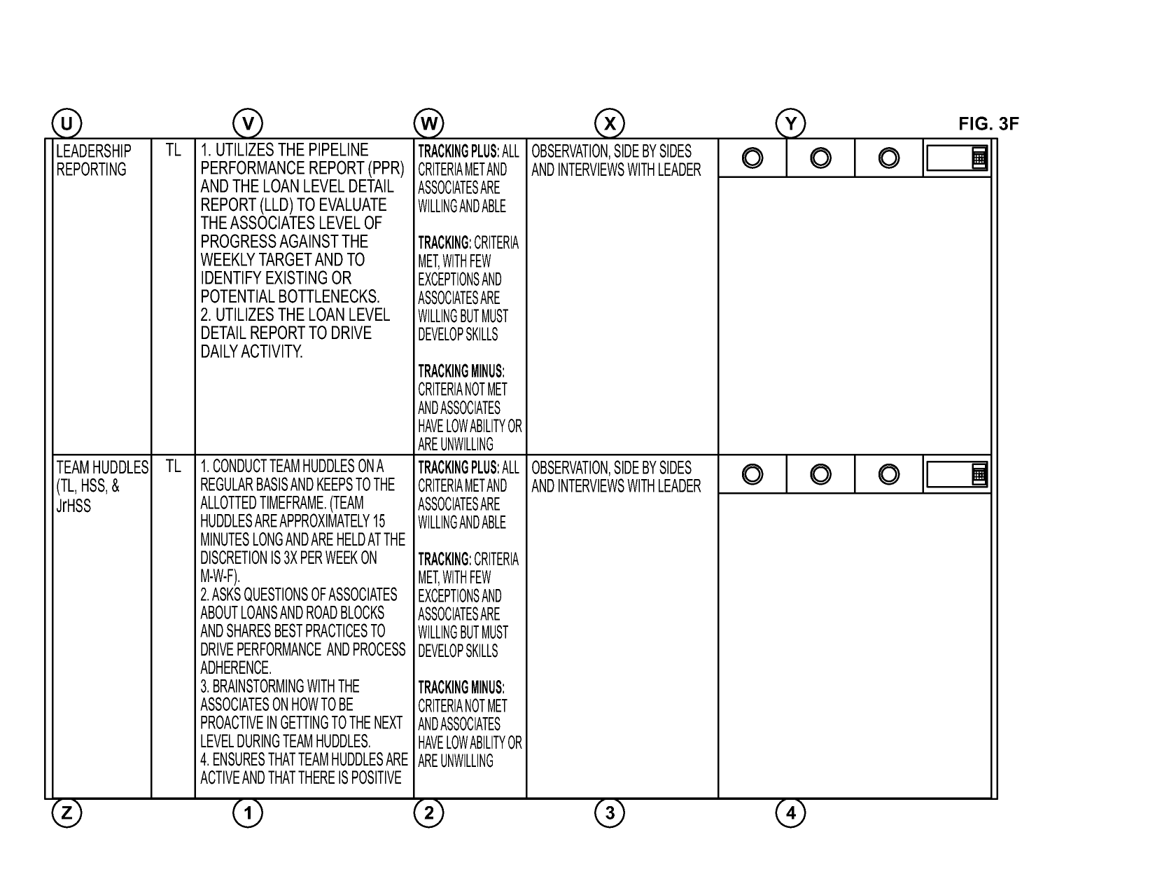

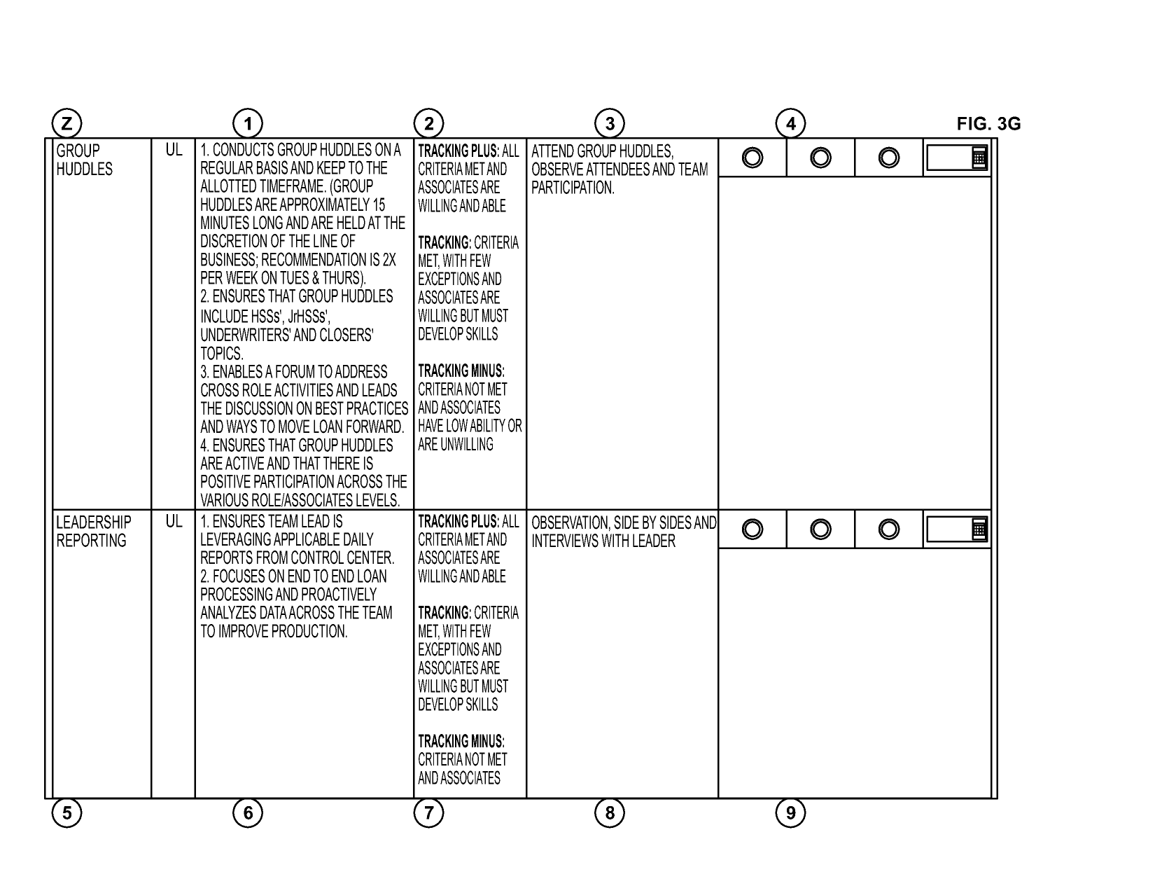

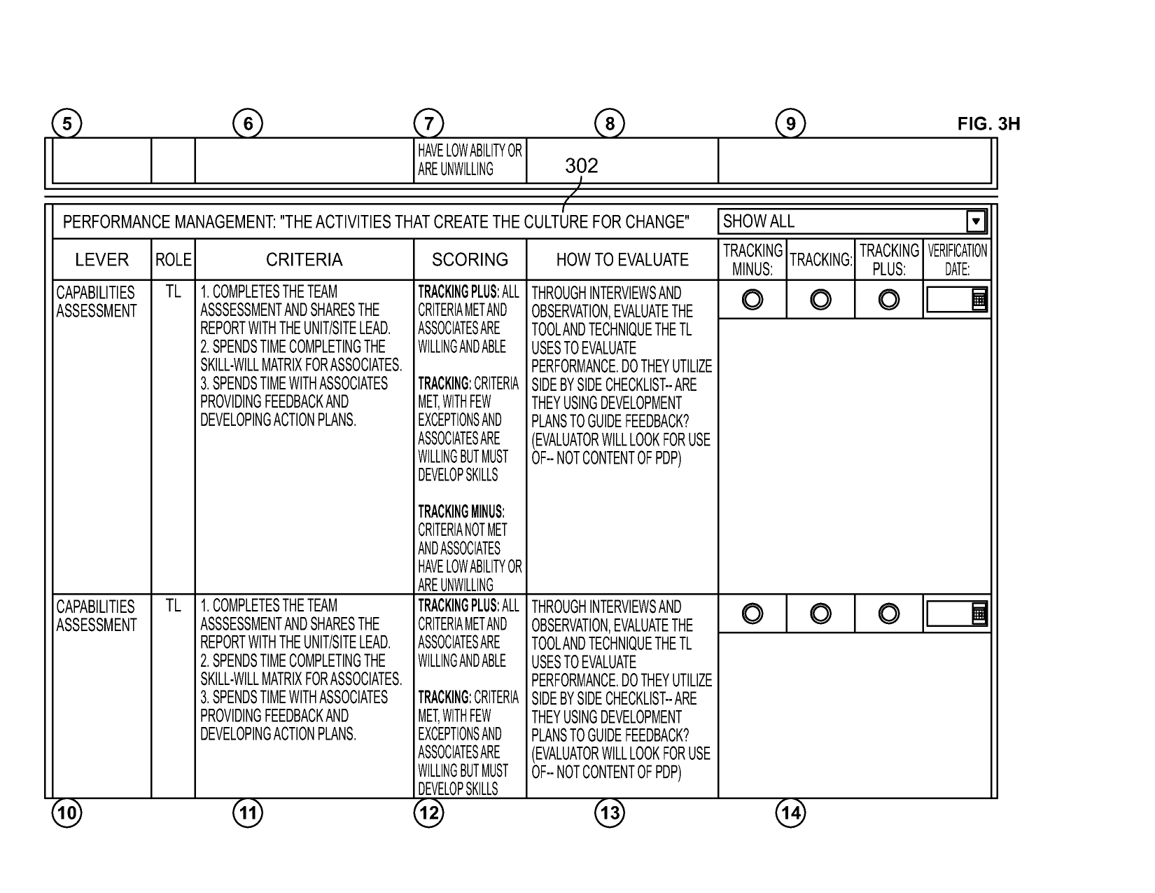

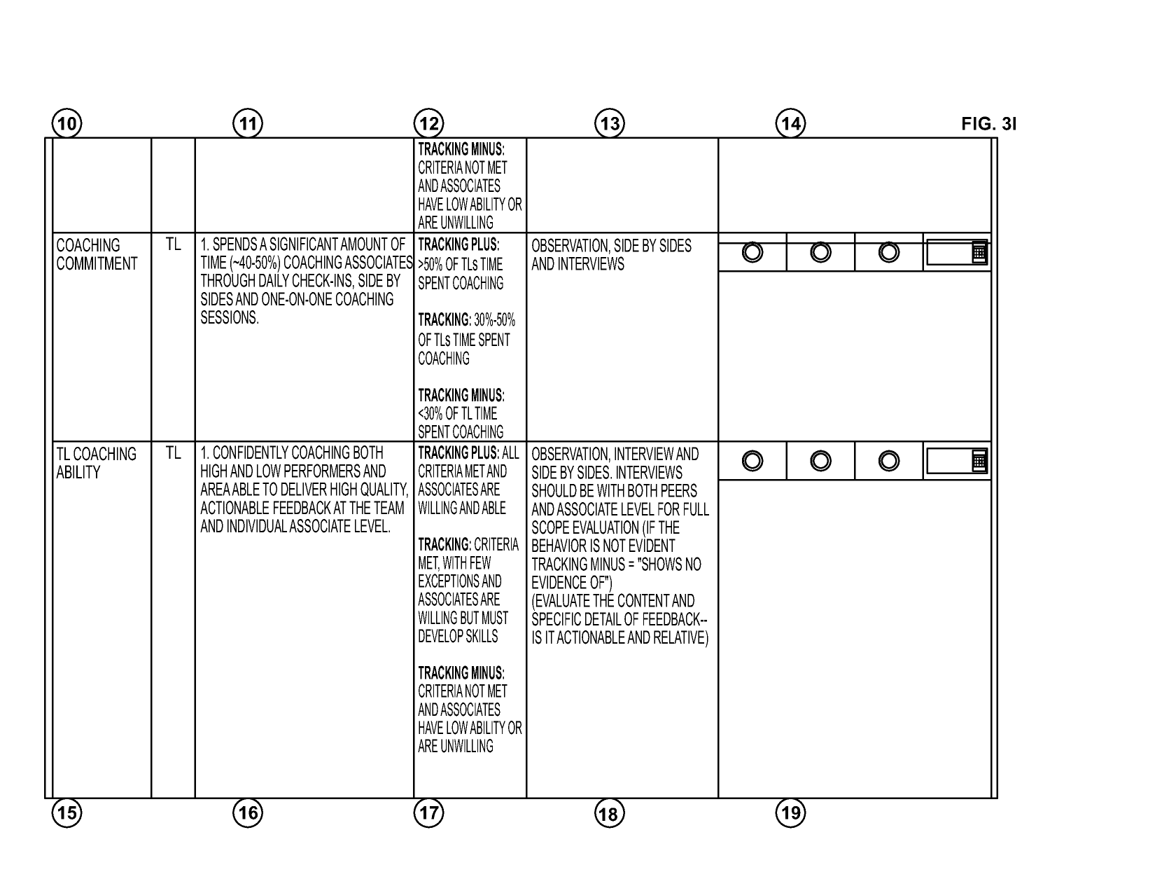

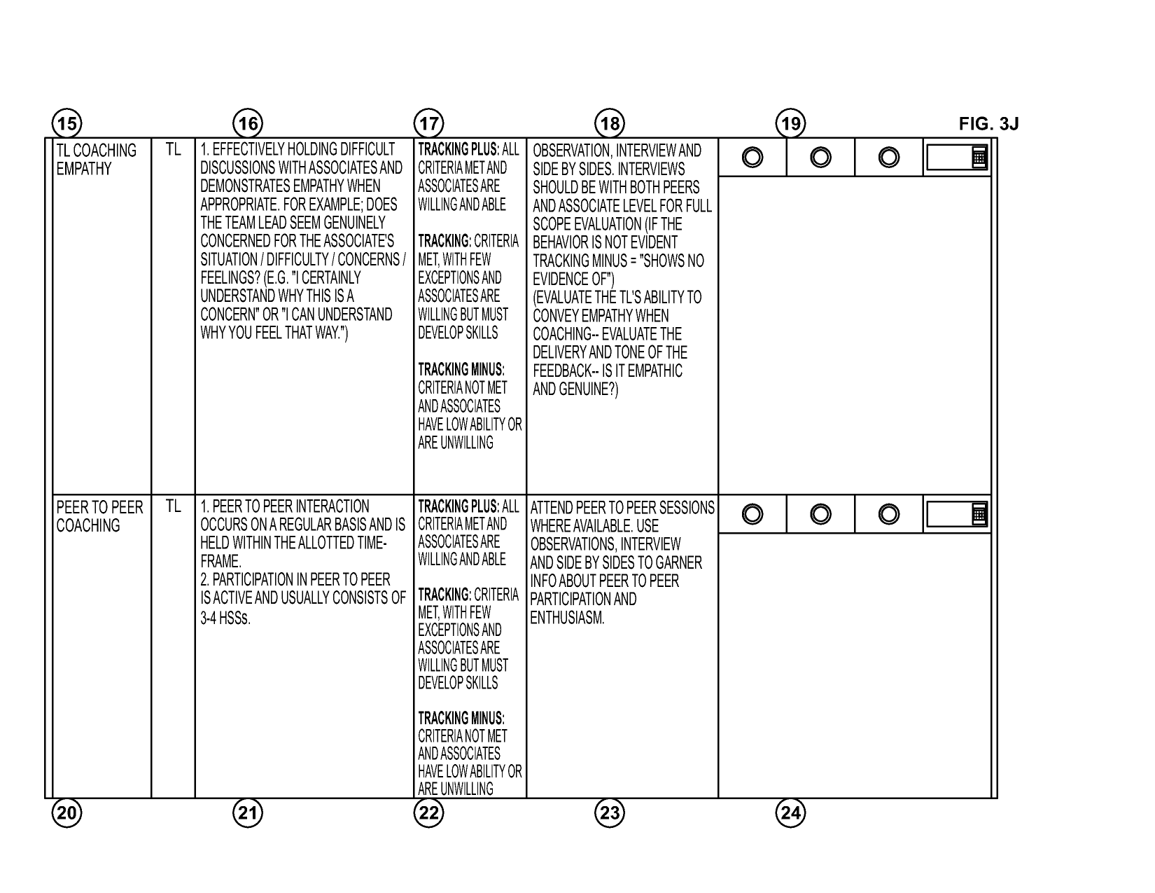

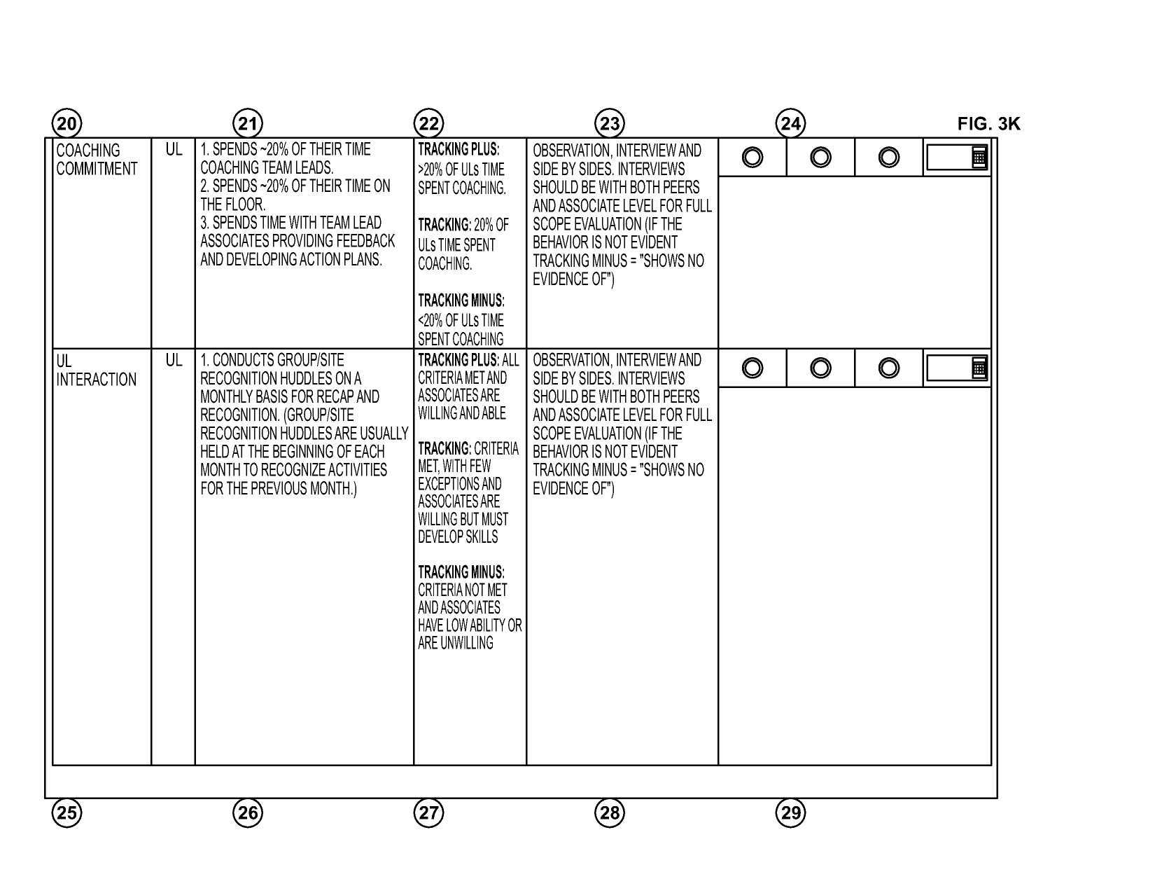

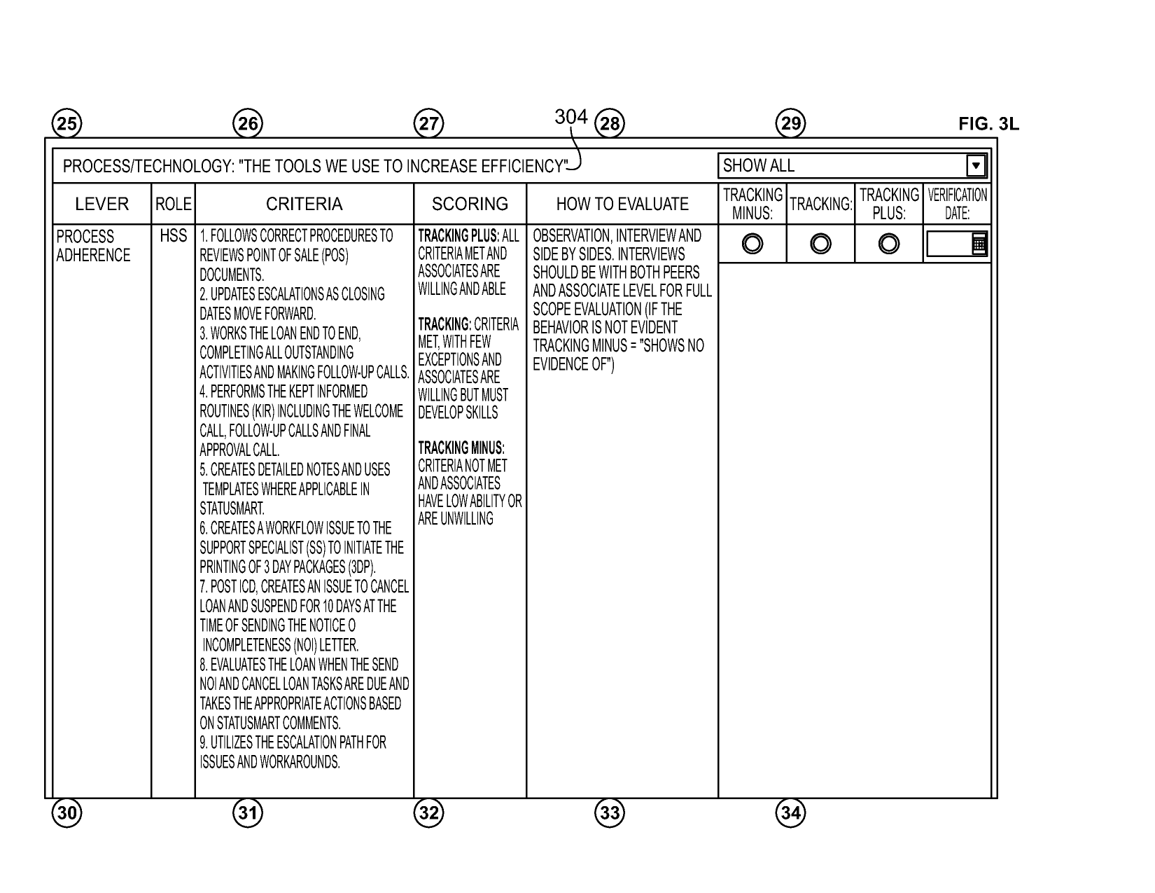

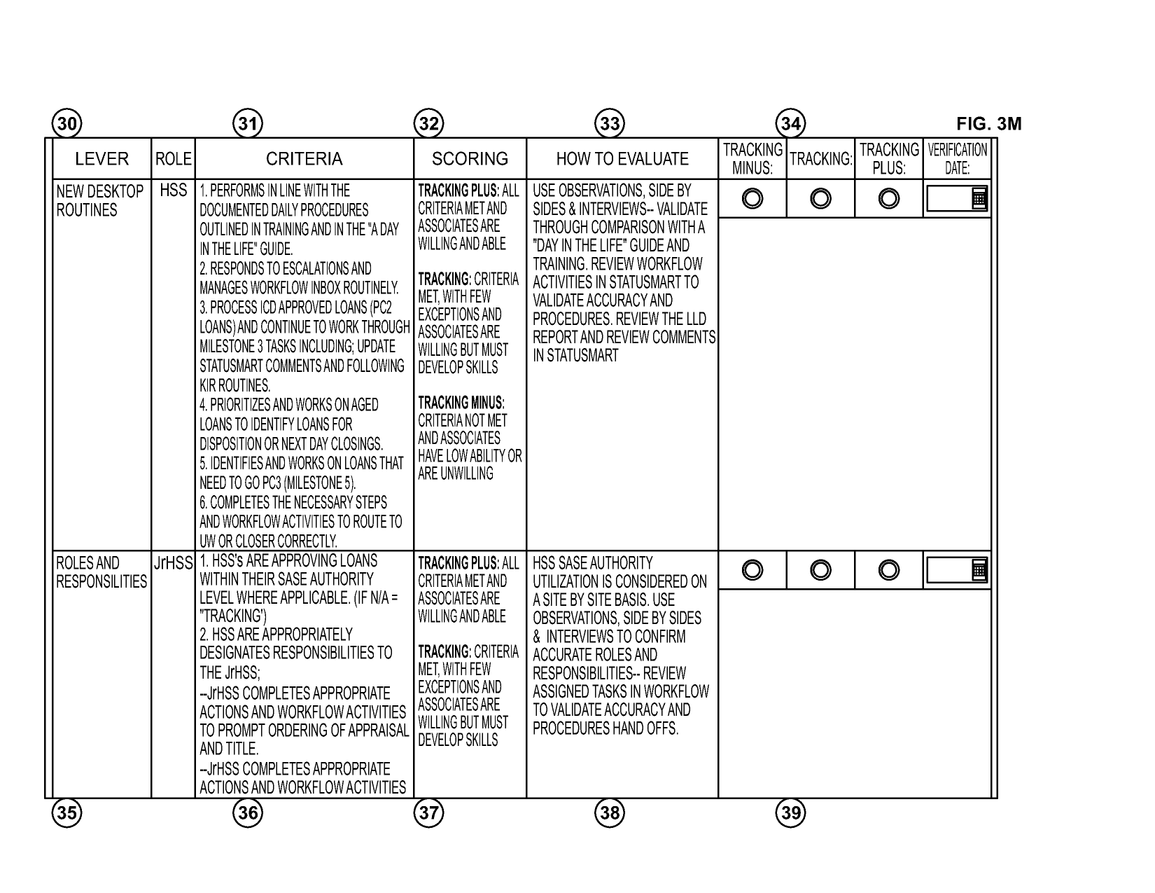

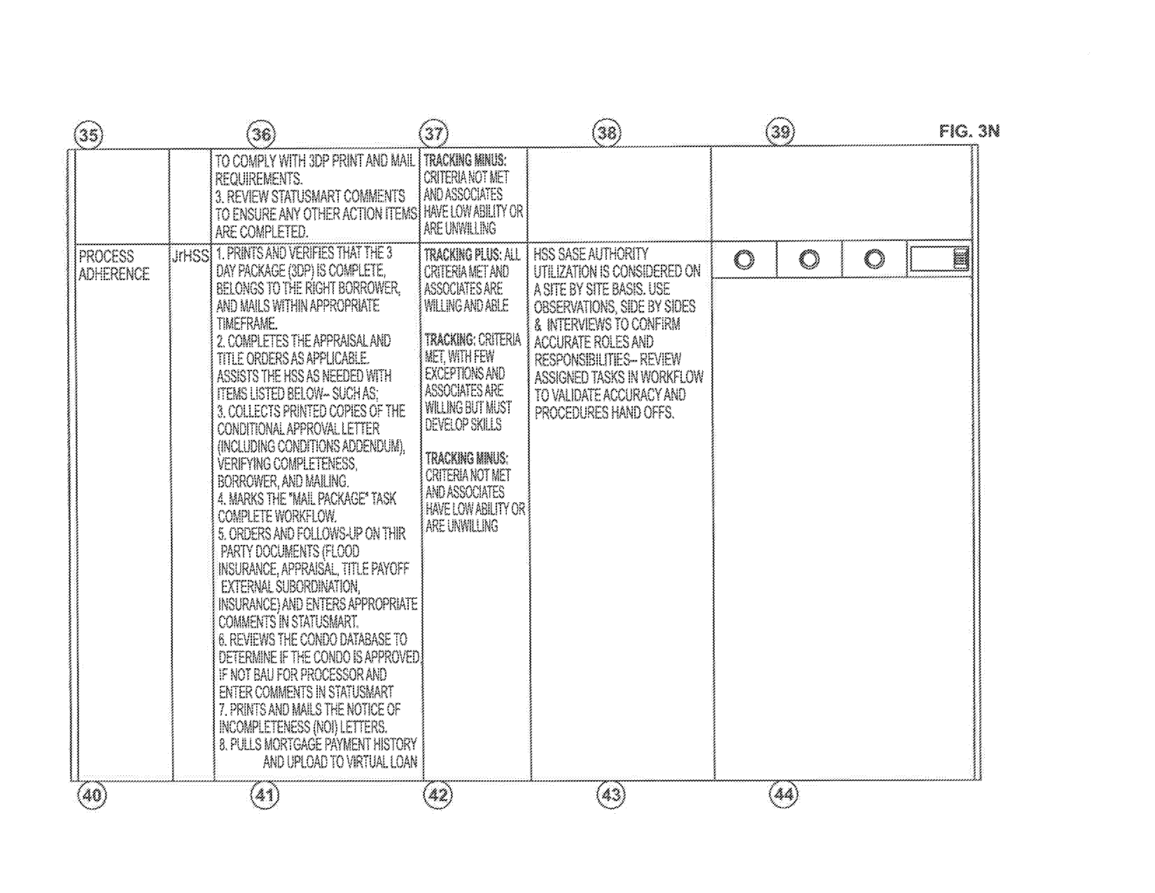

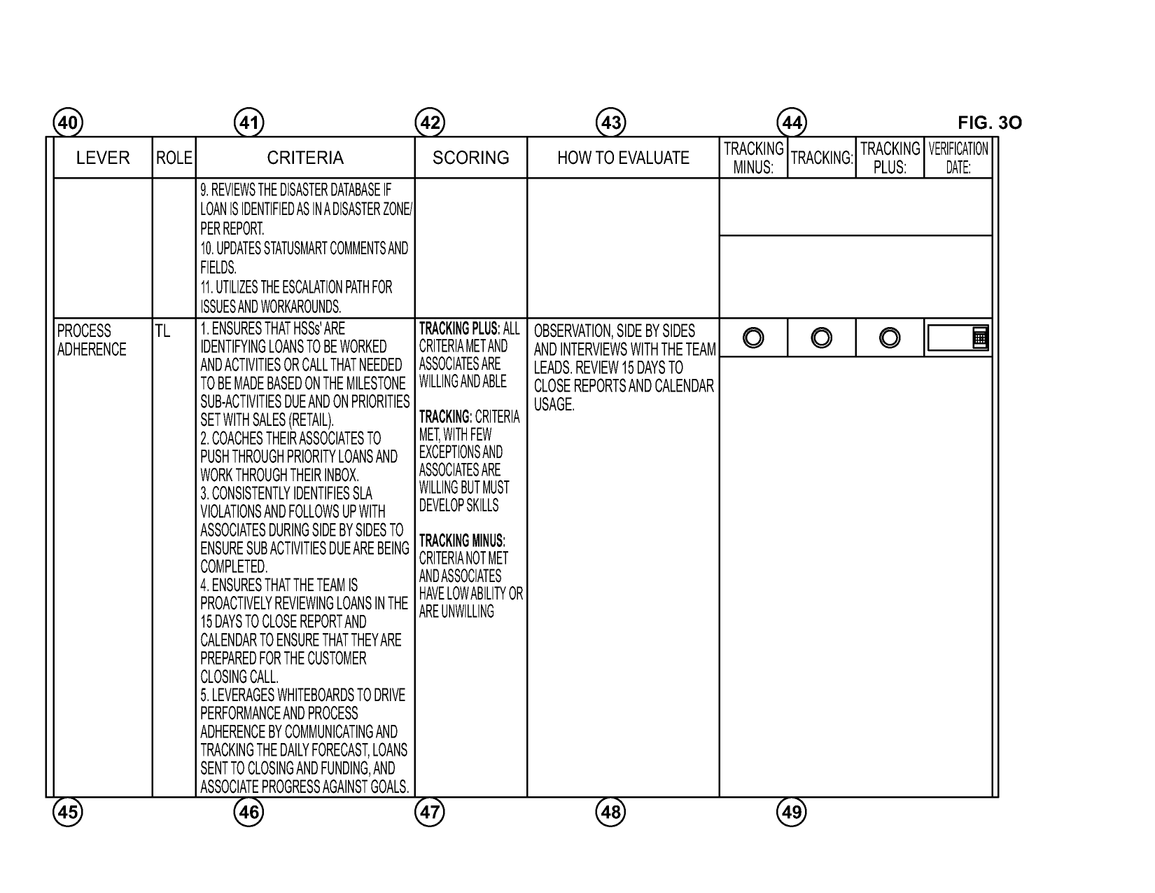

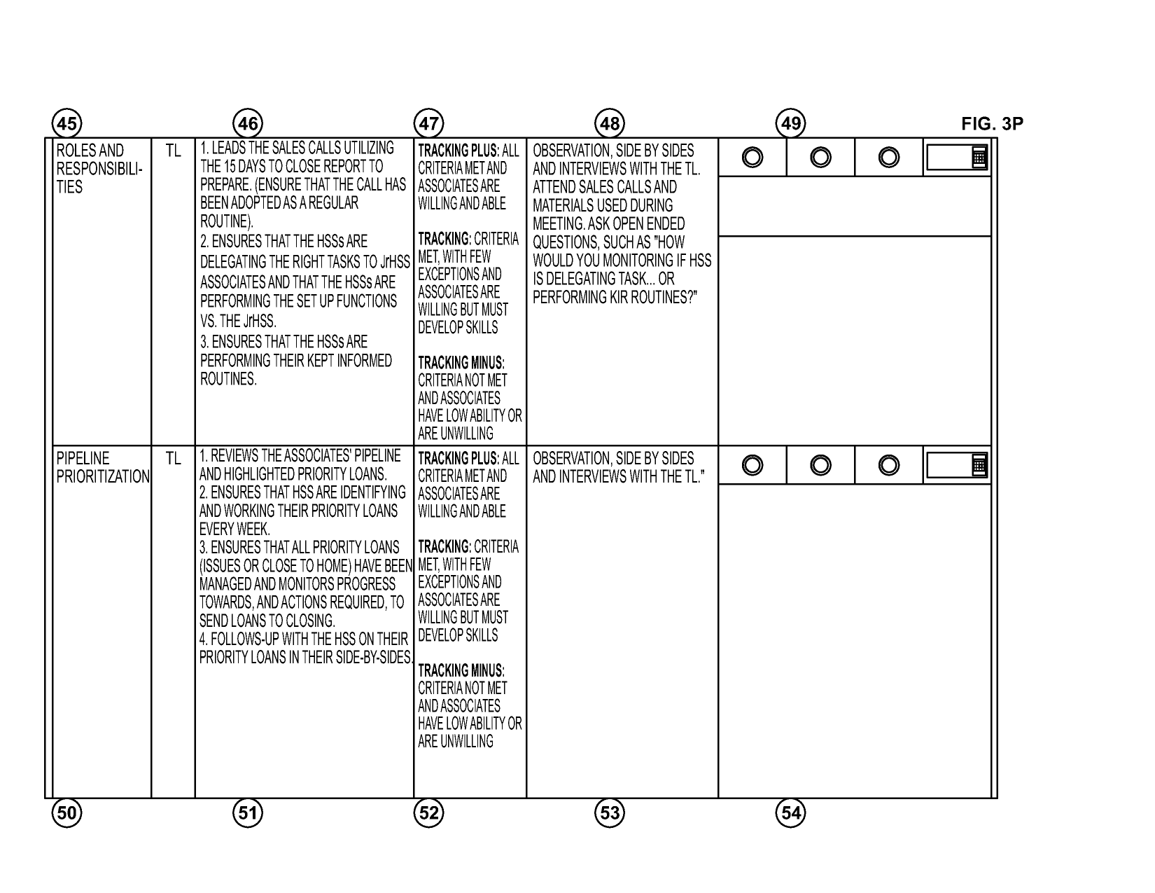

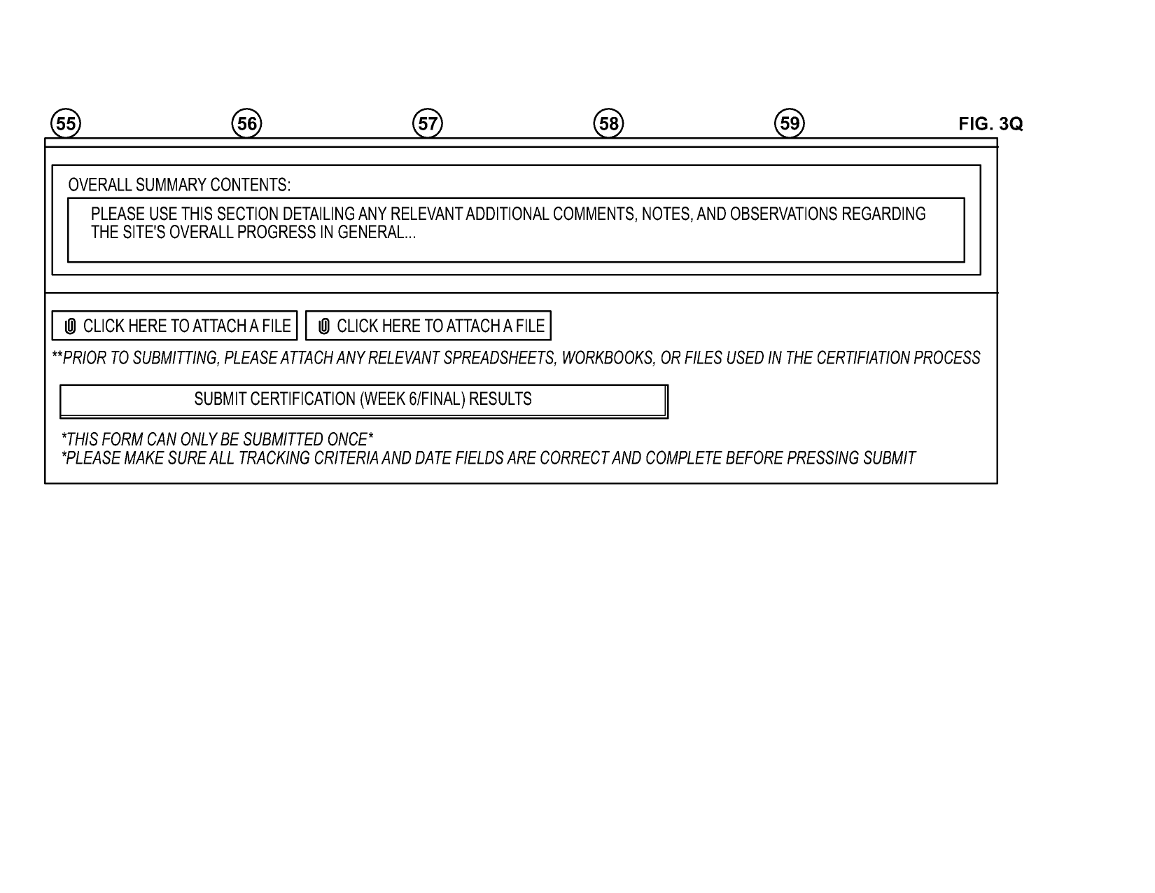

FIG. 3 shows illustrative information 300. Information 300 includes an illustrative post-deployment assessment form.

Information 300 includes management routine section 301, performance management section 302 and process/technology section 304.

Information 300 includes column 303. Column 303 lists a lever associated with management routine section 301. The lever may be a routine associated with a process change. Each lever in column 303 may be associated with a role in column 305. Column 305 identifies a class of employee responsible for compliance with the lever listed in column 303. Column 307 lists adoption factors associated with adherence to a lever listed in column 303. Column 309 relates the adoption factors listed in column 307 to a score. Column 311 provides specific scoring parameters consistent with an operational goal associated with the process change.

Each of sections 301, 302 and 304 may include a lever associated with an operational goal of a process change. Scoring levers listed in sections 301, 302 and 304 may indicate a successful or failed implementation of a process change.

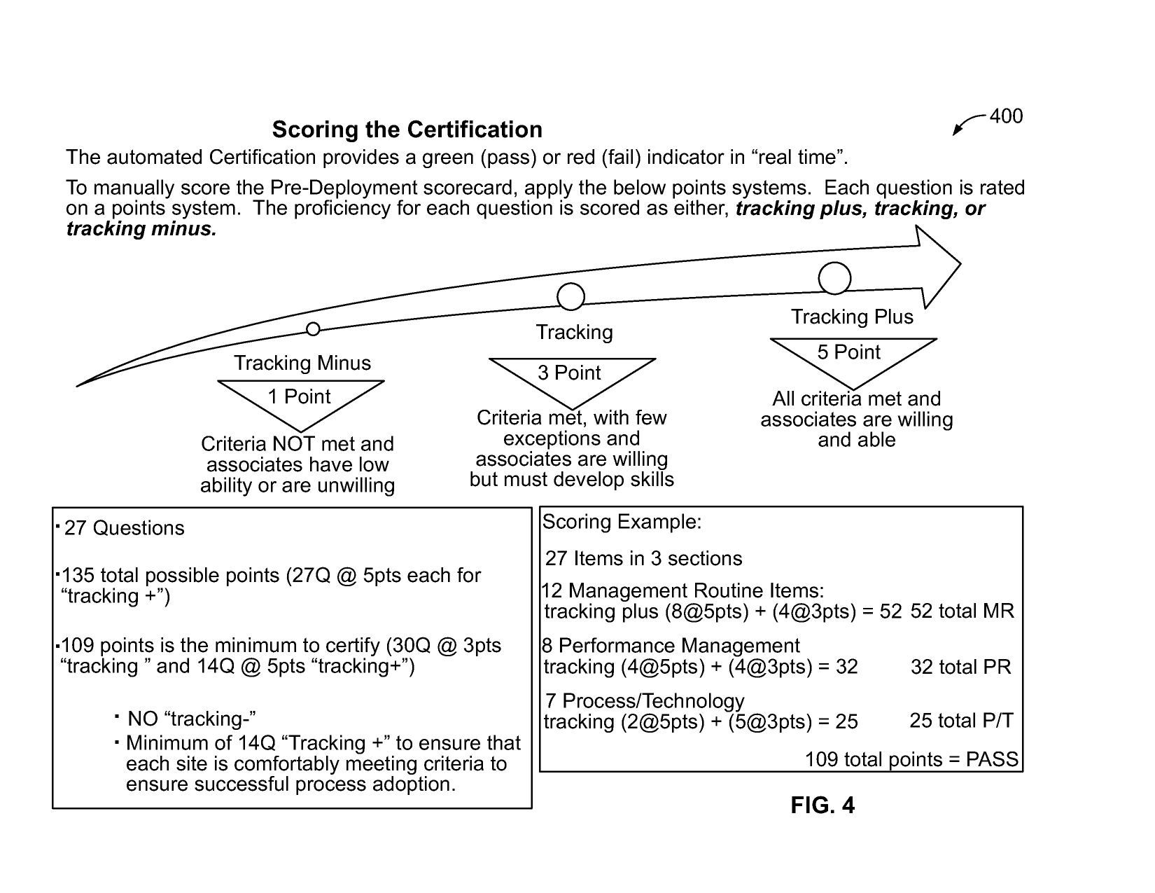

FIG. 4 shows illustrative information 400. Information 400 presents a method of certification. The method of certification may be based on information entered into per-deployment assessment shown in FIG. 2 and/or the post-deployment assessment shown in FIG. 3. The method of certification shown in FIG. 4 may determine whether a process change has been successfully implemented.

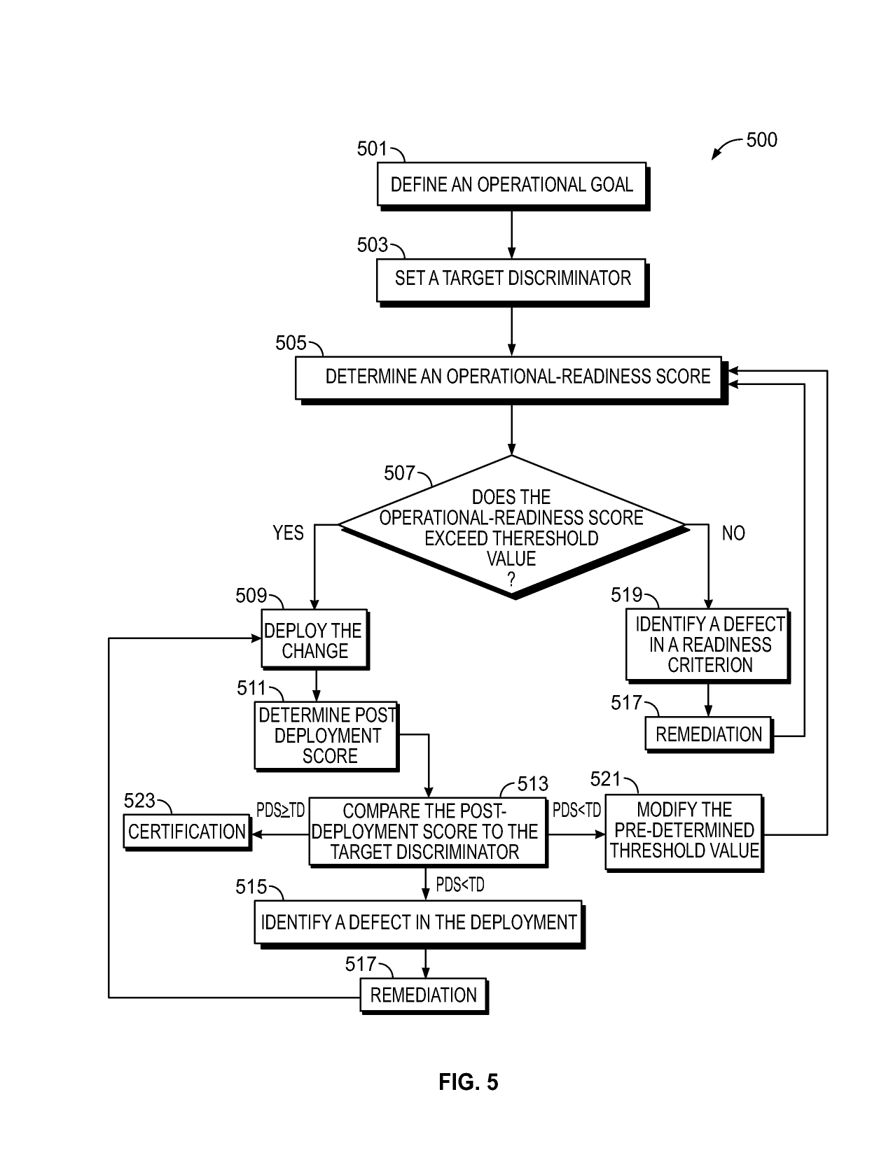

FIG. 5 shows illustrative process 500. Process 500 begins with defining an operational goal at step 501. The operational goal may correspond to a projected advantageous effect of implementing a change in an operational process. At step 503, a target discriminator is set. The target discriminator may correspond to one or more metrics embodying the projected effect of the change.

At step 505, an operational readiness score is determined. The operational readiness score may correspond to a state of readiness of employees tasked with implementing the change. At step 507, the operational readiness score is compared to a threshold value. The threshold value may correspond to a state of readiness associated with the operational goal.

If the operational readiness score is less than the threshold value, at step 519, a defect in completion of a readiness criterion is identified. An operational readiness score that is less than the threshold indicates that one or more employees tasked with implementing the change has not obtained a requisite level of preparation to successfully implement the change. At step 517, remediation may be provided to cure the preparation deficiency.

If the operational score exceeds the threshold, at step 509, the change will be deployed. An operational score that exceeds the threshold indicates that employees tasked with implementing the change have obtained a requisite state of readiness associated with the operational goal.

After deploying the change, at step 511, a post-deployment score is determined. The post-deployment score corresponds to a measured effect of implementing the change. At step 513, the post-deployment score is compared to the target discriminator. If the post-deployment sore is greater than or equal to the target discriminator, the change is certified at step 523. A post-deployment score that is greater than or equal to the target discriminator indicates that the operational goal associated with the change has been achieved.

If the post-deployment score is less than the target discriminator, the operational goal associated with the change has not been achieved. In response to deficiencies in the post-deployment score, at step 515, a defect in the deployment may be identified. At step 517, remedial action may be taken to cure the defect in a subsequent deployment of the change.

In response to deficiencies in the post-deployment score, at step 521, the threshold value may be modified. An error in the threshold value may correspond to a deficiency in preparation to implement the change. The threshold may be modified to require additional or more rigorous preparation/training prior to a subsequent deployment of the change.

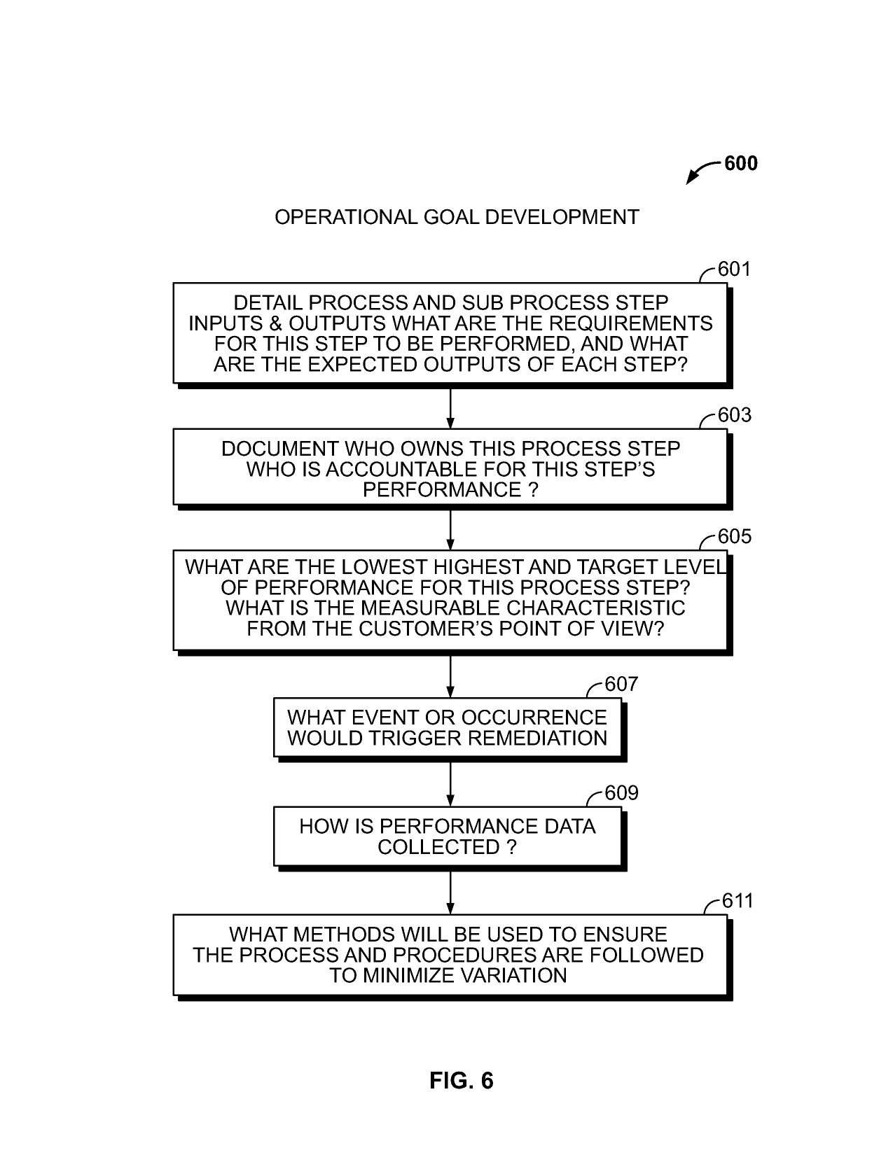

FIG. 6 shows illustrative information 600. Information 600 outlines steps for developing an operational goal associated with a change in an operational process.

At step 601, for each process and sub-process included in a proposed change to an operational process, inputs and outputs of each process and sub-process are identified. Step 601 includes identifying input requirements to perform each process and sub-process, and identifying expected outputs generated by each process and sub-process.

At step 603, a party responsible for performance of a particular process or sub-process in the proposed change is documented. The documenting may clearly identify a party accountable for performance of the particular process or sub-process.

At step 605, the lowest highest and target level of performance for a particular process step are identified. Step 605 includes articulating a measurable performance characteristic corresponding to the highest/lowest target level from a point of view of a customer affected by the process change.

At step 607, an event or occurrence that would trigger remediation is identified. The event or occurrence may correspond to an unacceptable level of performance implementing the change. The level of performance may be determined to be unacceptable based on the measureable performance characteristic associated with the point of view of the customer, or any other suitable metric.

At step 609, methods for collecting performance data are identified. The methods may include utilizing information 200 (shown in FIG. 2) or information 300 (shown in FIG. 3). At step 611, methods are developed to ensure compliance with the processes and sub-processes required to successfully implement the change in the operational process.

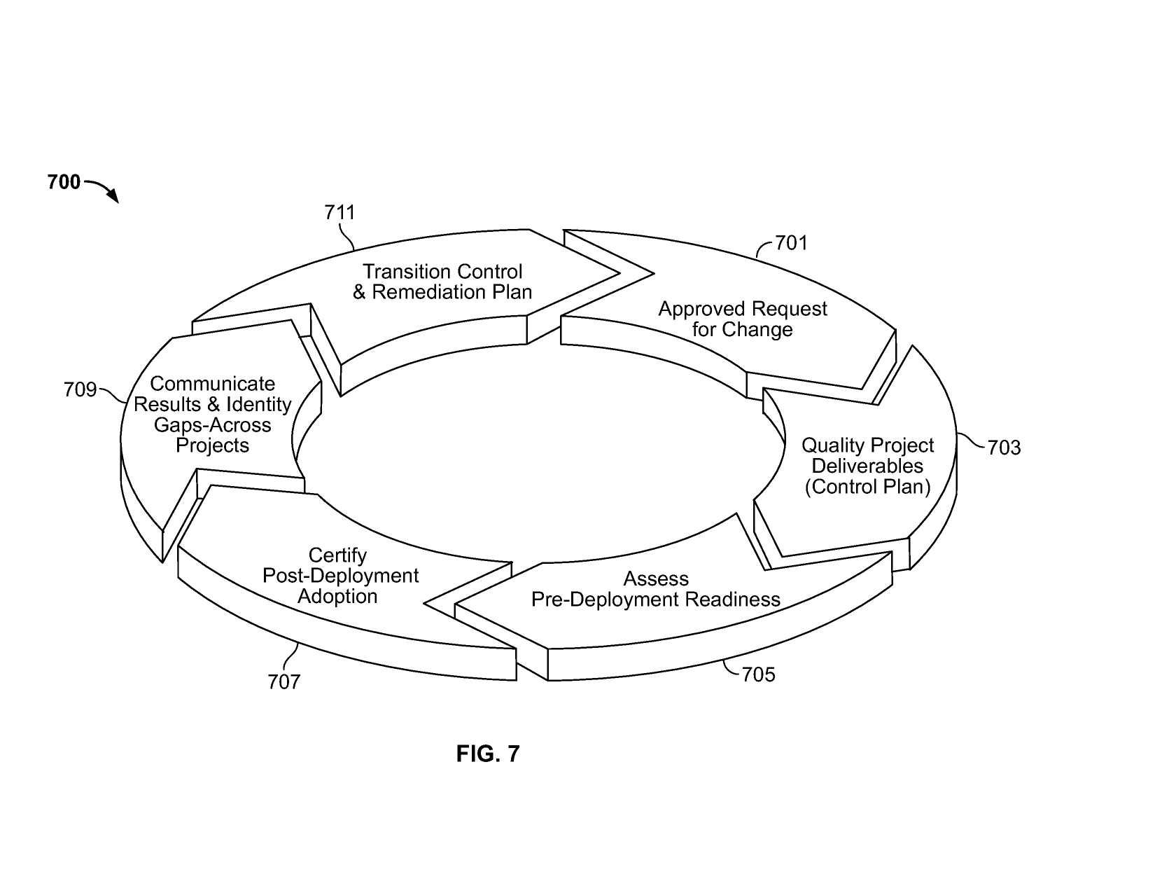

FIG. 7 shows illustrative process 700. Process 700 begins at step 701. At step 701, a request to implement a change to an operational process is approved. At step 703, a control plan is developed. The control plan may include one or more of the features of process 600 (shown in FIG. 6). At step 705, a readiness state is assessed. The assessment of the readiness state may be based on determining a pre-deployment score or an operational readiness score. If the readiness state is commensurate with a level of preparation mandated by the control plan, the change may be deployed (not shown). In some embodiments, the change may be deployed prior to assessing pre-deployment readiness (not shown).

At step 707, post-deployment compliance with goals of the process change is assessed. If the assessment indicates that the process change has been implemented successfully, the change may be certified. If the change is not certified, at step 709, deficiencies in a performance implementing the change are identified. At step 711, remedial steps are taken to align the performance attempting to implement the change with the stated goals and requirements associated with the change.

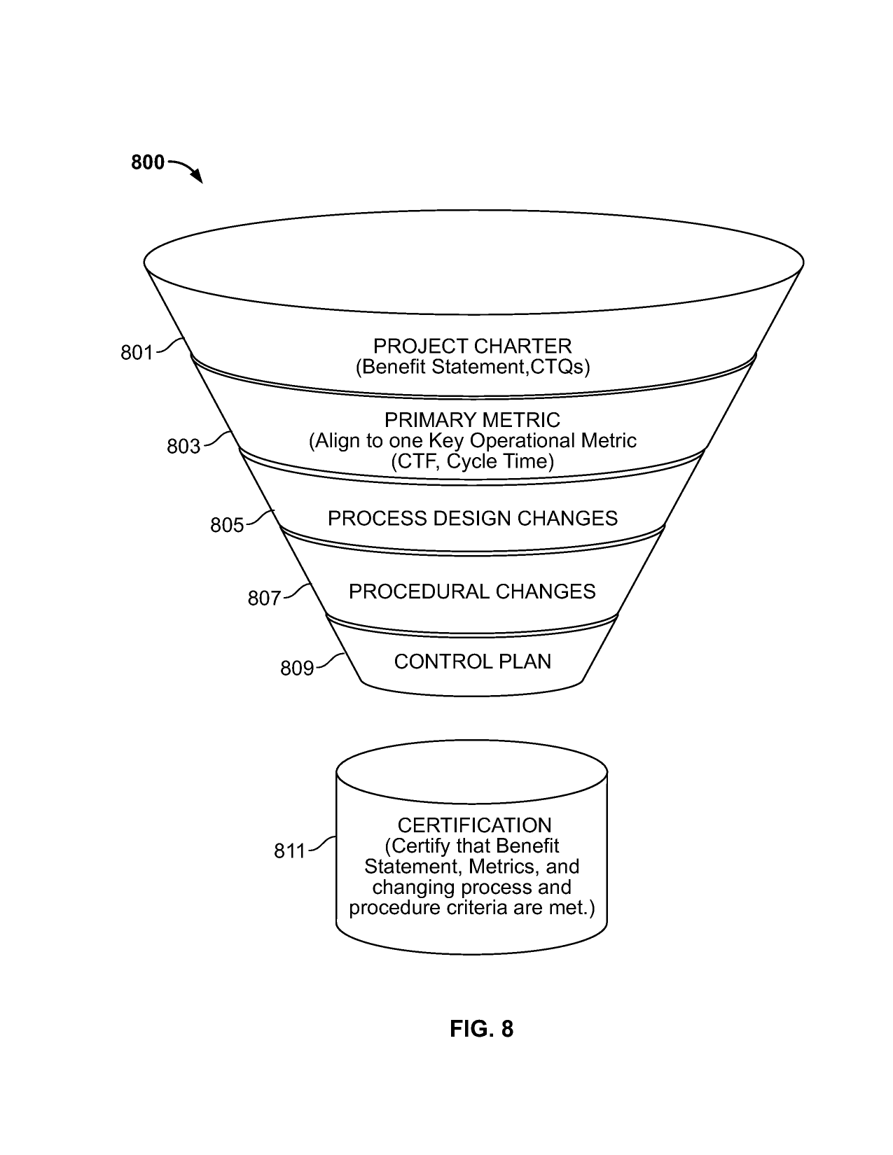

FIG. 8 shows illustrative information 800. Information 800 shows inputs 801-809 that feed into certification process 811. Certification process 811 is conducted based on comparing inputs 801-809 to results of a performance implementing a process change. The results of the performance may be determined using information 200 (shown in FIG. 2) or information 300 (shown in FIG. 3). Inputs 801-809 may determine the target of the performance (not shown). Inputs 801-809 may determine the target discriminator (not shown). Inputs 801-809 may determine the pre-determined threshold value (not shown).

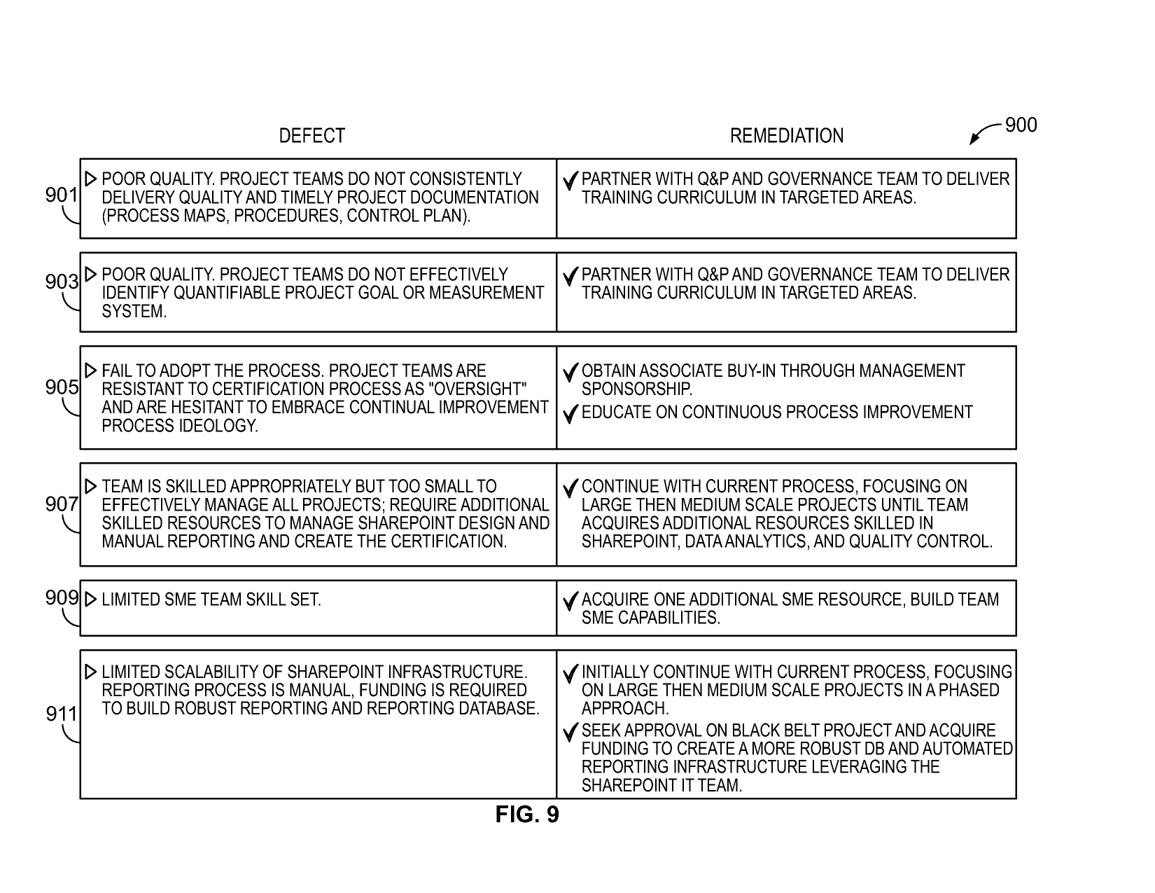

FIG. 9 shows illustrative information 900. Information 900 includes exemplary defects in column 901 and corresponding remedial action in column 903. Defects in column 901 may be identified based on a pre-deployment assessment (shown in FIG. 2) or a post-deployment assessment (shown in FIG. 3). Defects shown in FIG. 9 include preparation defects 901 and 903. Defects shown in FIG. 9 include implementation defect 905. Defects shown in FIG. 9 include threshold selection errors 907, 909 and 911.

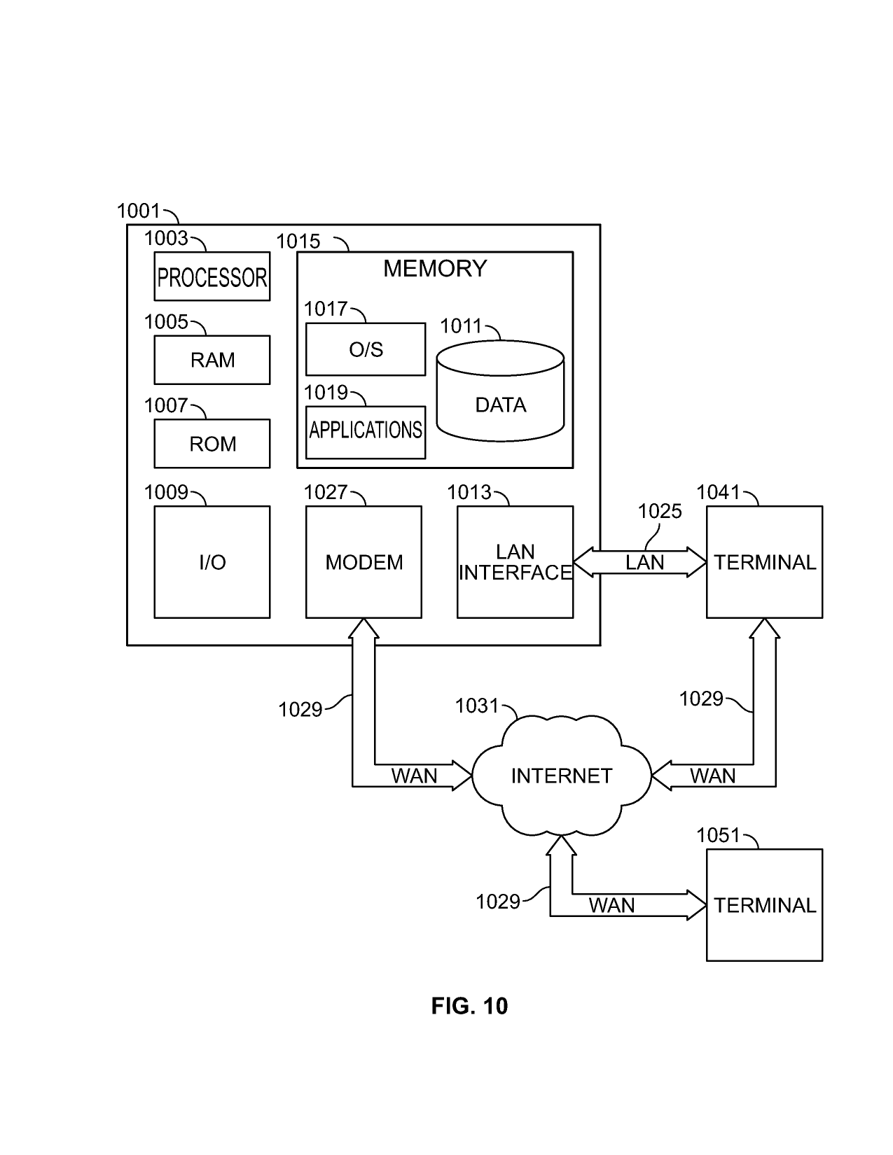

FIG. 10 is a block diagram that illustrates a generic computing device 1001 (alternatively referred to herein as a “server”) that may be used in accordance with the principles of the invention. Server 1001 may be included in any suitable apparatus that is shown or described herein.

Server 1001 may have a processor 1003 for controlling overall operation of the server and its associated components, including RAM 1005, ROM 1007, input/output module 1009, and memory 1015.

Input/output (“I/O”) module 1009 may include a microphone, keypad, touch screen, and/or stylus through which a user of device 1001 may provide input, and may also include one or more of a speaker for providing audio output and a video display device for providing textual, audiovisual and/or graphical output. Software may be stored within memory 1015 and/or storage to provide instructions to processor 1003 for enabling server 1001 to perform various functions. For example, memory 1015 may store software used by server 1001, such as an operating system 1017, application programs 1019, and an associated database 1011. Alternatively, some or all of server 1001 computer executable instructions may be embodied in hardware or firmware (not shown). Database 1011 may provide storage for inputs, outputs, feedback, remedial action, pre-deployment scores, post-deployment scores and/or any other suitable information.

Server 1001 may operate in a networked environment supporting connections to one or more remote computers, such as terminals 1041 and 1051. Terminals 1041 and 1051 may be servers that include many or all of the elements described above relative to server 1001. The network connections depicted in FIG. 10 include a local area network (LAN) 1025 and a wide area network (WAN) 1029, but may also include other networks such as an intranet. When used in a LAN networking environment, computer 1001 is connected to LAN 1025 through a network interface or adapter 1013. When used in a WAN networking environment, server 1001 may include a modem 1027 or other means for establishing communications over WAN 1029, such as Internet 1031. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 1019, which may be used by server 1001, may include computer executable instructions for invoking user functionality related to communication, such as email, short message service (SMS), and voice input and speech recognition applications.

Computing device 1001 and/or terminals 1041 or 1051 may also be mobile terminals including various other components, such as a battery, speaker, and antennas (not shown).

Terminal 1051 and/or terminal 1041 may be portable devices such as a laptop, cell phone, blackberry, or any other suitable device for storing, transmitting and/or transporting relevant information.

Any information described above in connection with database 1011, and any other suitable information, may be stored in memory 1015.

One or more of applications 1019 may include one or more algorithms that may be used to implement process change control.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Thus, methods and apparatus for process change control have been provided. Persons skilled in the art will appreciate that the present invention can be practiced by other than the described embodiments, which are presented for purposes of illustration rather than of limitation, and that the present invention is limited only by the claims that follow.

1. A method for achieving a target of a performance, the method comprising:
receiving an input based on the performance;
discriminating, in the input, between:
a preparation defect;
an implementation defect; and
a threshold selection error;
based on the discriminating, providing an outcome;
based on the outcome, adjusting a feedback that feeds hack into the performance; and
certifying the performance when the input satisfies a certification score.

2. The method of claim 1 wherein the discriminating comprises receiving a pre-deployment score based on the input.

3. The method of claim 2 wherein the pre-deployment score is based on measuring a level of pre-performance preparation.

4. The method of claim 1 wherein the discriminating comprises receiving a post-deployment score based on the input.

5. The method of claim 4 wherein the post-deployment score is based on measuring a compliance frequency of a routine associated with the target.

6. The method of claim 2 wherein the feedback comprises a minimum level of pre-performance preparation.

7-19. (canceled)

20. An article of manufacture comprising:
a computer usable medium having computer readable program code embodied therein for achieving a target of a performance, the computer readable program code in said article of manufacture comprising:
computer readable program code for causing a computer to receive an input based on the performance;
computer readable program code for causing a computer to discriminate, in the input, between:
a preparation defect;
an implementation defect; and
a threshold selection error;
computer readable program code for causing a computer to, based on the discriminating, provide an outcome;
computer readable program code for causing a computer to, based on the outcome, adjust a feedback that feeds back into the performance;
computer readable program code for causing a computer to certify the performance when the input satisfies a certification score.

21. A method for reducing defects associated with a change in an operational process, the change implemented by a project team, the method comprising:
defining an operational goal of the change;
setting a target discriminator based on the operational goal;
determining an operational-readiness Score based on the operational goal;
if the operational-readiness score exceeds a pre-determined threshold value:
deploying the change;
determining a post-deployment score based on operational metrics measured after the deploying;
comparing the post-deployment score to the target discriminator; and
based on the comparing:
identifying a defect in the deploying; or
modifying the pre-determined threshold value; and
if the operational-readiness score does not exceed the pre-determined threshold value, identifying a detect in a readiness criterion.

22. The method of claim 21, wherein defining the operational goal comprises:
identifying an operational requirement of the change;
identifying an output produced by fulfillment of the operational requirement;
allocating responsibility for fulfillment of the operational requirement;
identifying a target level of performance associated with fulfillment of the operational requirement; and
defining a remedial process to minimize variation in the output produced by fulfillment of the operational requirement.

23. The method of claim 21, wherein determining the operational-readiness score comprises:
identifying a prerequisite operational task associated with the change;
validating compliance with the prerequisite operational task; and
based on the identifying and the validating, determining the operational-readiness score.

24. The method of claim 21, wherein determining the operational-readiness score comprises assigning a value to a performance parameter associated with a completion of a plurality of readiness tasks.

25. The method of claim 24, the scoring comprising determining a score for each of the readiness tasks based on a key component of each of the readiness tasks.

26. The method of claim 21, wherein, determining the post-deployment score comprises:
calculating a first score based on an adherence to a routine associated with the process change;
calculating a second score based on a managerial performance;
calculating a third score based on utilization of efficiency tools; and
calculating a total score based on the first, second and third scores.

27. The method of claim 26, wherein the routine associated with the process change comprises:
achieving a milestone associated with the process change;
utilizing a report available to the project team; and
providing guidance to a member of the project team.

28. The method of claim 27 wherein providing guidance to a member of the project team comprises:
conducting a project team strategy session; and
coaching a member of the project team.

29. The method of claim 21 further comprising, determining the post-deployment score:
at a first interval following deployment of the process change;
at a second interval following deployment of the process change; and
at a third interval following deployment of the process change.

30. The method of claim 29, wherein the first interval is two weeks, the second interval is four weeks and the third interval is seven weeks.

31. The method of claim 29 further comprising, determining the post-deployment score:
at least twice by the project team; and
at least once by an onsite deployment support team.

32. The method of claim 1, wherein when the outcome comprises a threshold selection error, the feedback comprises adjusting the certification score.

33. The method of claim 5 wherein the feedback comprises a compliance frequency minimum.
